(19) United States
(12) Patent Application Publication
(10) Pub. No.: US 2024/0314679 A1
(43) Pub. Date: Sep. 19, 2024

(54) METHOD AND DEVICE FOR SESSION ESTABLISHMENT AND CONTROL

(71) Applicant: Samsung Electronics Co., Ltd., Suwon-si, Gyeonggi-do (KR)

(72) Inventors: Lisi LI, Beijing (CN); Hong WANG, Beijing (CN); Lixiang XU, Beijing (CN)

(21) Appl. No.: 18/681,501

(22) PCT Filed: Aug. 2, 2022
(86) PCT No.: PCT/KR2022/011415

§ 371 Date: Feb. 5, 2024

(30) Foreign Application Priority Data
Aug. 4, 2021 (CN) 202110891878.9
Oct. 18, 2021 (CN) 202111210481.5
Jan. 5, 2022 (CN) 202210006397.X

(51) Int. Cl. H04W 48/18; H04W 28/02; H04W 48/02; H04W 48/16

(52) U.S. Cl. CPC H04W 48/18; H04W 28/0268; H04W 48/02; H04W 48/16

(57) ABSTRACT

The disclosure relates to a 5G or 6G communication system for supporting a higher data transmission rate. A method includes: receiving related information about usage of a network slice resource from a second node: when a network slice resource corresponding to a requested PDU session is not supported or shortage, allocating other available resource for requested PDU session by considering above information. Embodiments of present application implement method as provided, so network slice enhance can be achieved, network slices can be utilized better and allocated with reasonable resources, and continuity of service and quality of service are guaranteed in limited network resources available, thus practical application requirements are met better.

### TECHNICAL FIELD

The present application is directed toward the field of communication technology, in particular, to a method and a device for session establishment and control.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (cMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

To meet the demand for wireless data traffic having increased since deployment of 4G communication systems, efforts have been made to develop an improved 5G or pre-5G communication system. Therefore, the 5G or pre-5G communication system is also known as a “Beyond 4G Network” or a “Post LTE System”.

Wireless communication has been one of the most successful innovations in modern history. The number of subscribers to wireless communication services exceeded five billion and continues to grow quickly. The demand of wireless data traffic is rapidly increasing due to the increasing popularization of smart phones and other mobile data devices (e.g., tablet computers, notebook computers, netbooks, e-book readers, machine-type devices) among the consumers and enterprises. In order to meet the high growth in mobile data traffic and support new applications and deployments, it is critical to improve wireless interface efficiency and coverage range.

With the development of networks, reforming and innovations in industries such as manufacturing industry, transportations, energy sources, common services and healthcare are facilitated by the connectivity and the mobility of mobile communication networks, there will be strong demands for wireless communications in vertical markets. These different vertical services have brought widespread performance requirements in terms of throughput, capacity, delay, mobility, reliability, and positioning accuracy. In order to provide transactions having different demands with quality of service (QOS) based on demands, network slices are introduced into mobile communication networks. A network slice is an end-to-end logical slice, and each of the slices has different QoSs and may provide services for different transactions and users. One of the important developing directions to enhance network slices is how to make better use of network slices and allocate reasonable resources for network slices, so as to guarantee the continuity of the service and the quality of service in the limited network resources available.

### DISCLOSURE OF INVENTION

### Solution to Problem

An objective of the present application is intended to solve at least one of the technical defects in the existing communication ways, and to further improve communication ways, so that practical communication demands are met better. In order to achieve the objective, the technical solutions proposed by the present application are as follows:

According to a first aspect, there is provided a session establishment method, the method including:
receiving, by a first node, related information about usage of a network slice resource from a second node;
when a network slice resource corresponding to a requested PDU session is not supported or shortage, allocating, by the first node, other available resource for the requested PDU session by considering the information.

According to a second aspect, there is provided a session establishment method, the method including:
sending, by a first node, to a user equipment, UE, related information for performing of restricting network slice(s), and when scheduling the UE, sending, by the first node, related information for indicating performing of restricting network slice(s) to the UE.

According to a third aspect, there is provided a session establishment method, the method including:
determining, by a first node, network slice information requested by a user equipment, UE, and supported by a fourth node;
sending, by the first node, the network slice information requested by the UE and supported by the fourth node to a second node.

According to a fourth aspect, there is provided a session establishment method, the method including:
receiving, by a first node, information for indicating that a PDU session resource needs to be established on a secondary node from a second node; and
sending, by the first node, a request message related to secondary node addition or modification to a fourth node.

According to a fifth aspect, there is provided a session establishment method, the method including:
receiving, by a second node, network slice information requested by a user equipment, UE, and supported by a fourth node which is sent by the first node; and
determining allowed network slice selection assistance information (NSSAI) for the UE or reassigning the allowed NSSAI according to the network slice information requested by the UE and supported by the fourth node.

According to a sixth aspect, there is provided a session establishment method, the method including:
receiving, by a user equipment, UE, related information for restricting network slice(s) which is sent by a first node;
when the UE is scheduled by the first node, receiving, by the UE, related information for indicating performing of restricting network slice(s) which is sent by the first node; and
performing, by the UE, uplink scheduling process according to the related information for restricting network slice(s) and the related information for indicating performing of restricting network slice(s).

According to a seventh aspect, there is provided an electronic device, the electrical device including a processor and a memory, and the processor and the memory are connected with each other; the memory device having stored therein computer programs that when executed by the processor, cause the processor to execute methods provided by any of optional embodiments of the present application.

Optionally, the electronic device may be a user equipment; when the above computer programs are run by the processor, a communication method executed by the UE provided by any of optional embodiments of the present application may be executed.

Optionally, the above electronic device is a base station; when the above computer programs are run by the processor, a communication method executed by the base station provided by any of optional embodiments of the present application may be executed.

Optionally, the above electronic device is a core network node device; when the above computer programs are run by the processor, a communication method executed by the core network node device provided by any of optional embodiments of the present application may be executed.

According to an eighth aspect, there is provided a computer readable storage medium which having stored therein computer programs, when the computer programs are run by the processor, a method provided by any of optional embodiments of the present application may be executed.

As to the beneficial effects brought by the provided technical solutions, explanation will be made hereinafter in conjunction with specific optional embodiments, which will not be described here.

### BRIEF DESCRIPTION OF DRAWINGS

In order to explain the technical solutions in the embodiments of the present application more clearly, the accompanying drawings used in the description of the embodiments of the present application will be briefly described below.

FIG. 1 is an exemplary system architecture diagram for the system architecture evolution (SAE) provided by an embodiment of the present application;

FIG. 2 is another exemplary system architecture diagram provided by an embodiment of the present application;

FIG. 3A is a schematic diagram of a procedure of a session establishment and control method provided by an embodiment of the present application;

FIG. 3B is a schematic diagram of a procedure of a session establishment and control method provided by another embodiment of the present application;

FIG. 4A1 is a schematic diagram of a procedure of a session establishment and control method provided by another embodiment of the present application;

FIG. 4A2 is a schematic diagram of a procedure of a session establishment and control method provided by another embodiment of the present application;

FIG. 4A3 is a schematic diagram of a procedure of a session establishment and control method provided by another embodiment of the present application;

FIG. 4B is a schematic diagram of a procedure of a session establishment and control method provided by another embodiment of the present application;

FIG. 5 is a schematic diagram of a flow of a session establishment and control method provided by another embodiment of the present application;

FIG. 6 is a schematic diagram of a procedure of a session establishment and control method provided by another embodiment of the present application;

FIG. 7A is a schematic diagram of a procedure of a session establishment and control method provided by another embodiment of the present application;

FIG. 7B is a schematic diagram of a procedure of a session establishment and control method provided by another embodiment of the present application;

FIG. 8 is a schematic diagram of a procedure of a session establishment and control method provided by another embodiment of the present application;

FIG. 9 is a schematic structure diagram of an electronic device provided by an embodiment of the present application;

FIG. 10 is a schematic diagram of a procedure of a session establishment and control method provided by another embodiment of the present application; and

FIG. 11 is a schematic diagram of a procedure of a session establishment and control method provided by another embodiment of the present application.

### MODE FOR THE INVENTION

Embodiments of the present application are described in detail hereinafter. The embodiments of the present application are illustrated in the drawings; wherein identical or similar reference numbers indicate identical or similar elements or elements having identical or similar functions throughout. Embodiments described with reference to the accompany drawings are exemplary, and are only for explaining the present application instead of being construed as limitations to the present invention.

It may be understood by those skilled in the art that the singular forms “a”, “an”, “said” and “the” used herein may also include the plural forms unless expressly stated otherwise. It will be further understood that the phrase “including”, when used in the description, specify the presence of stated features, integers, steps, operations, elements, and/or components and do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Further, “connection” or “coupling” used herein may include wireless connection or wireless coupling. The term “and/or” used herein includes all and any units and all the combinations of one or more of the associated listed items.

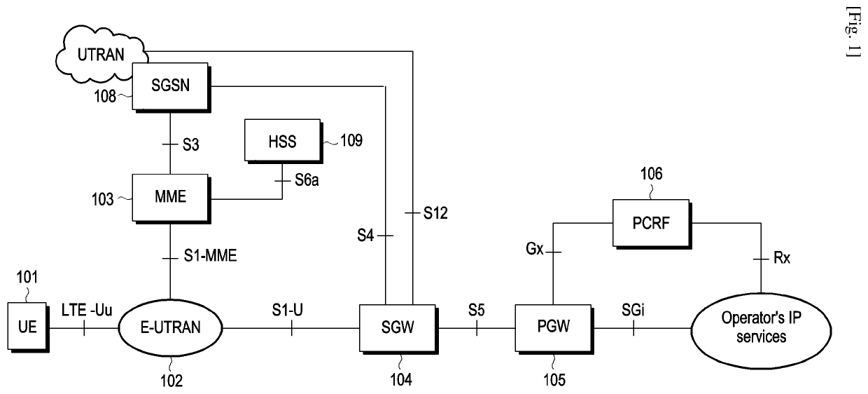

FIGS. 1 through 10, discussed below, and the various embodiments used to describe the principles of the present disclosure in the patent documents are by way of illustration only and should not be construed in any way to limit the scope of the present disclosure.

As will be appreciated by one skilled in the art, the principles of the present disclosure may be implemented in any systems or devices which are arranged properly.

FIG. 1 is an exemplary system architecture 100 of the System Architecture Evolution (SAE). A user equipment (UE) 101 is a terminal device used for receiving data. An Evolved Universal Terrestrial Radio Access Network (E-UTRAN) 102 is a radio access network in which macro base stations (eNodeB/NodeB) for providing an access wireless network interface for a UE are included. A Mobile Management Entity (MME) 103 is responsible for managing UE's mobility context, the session context, and the security information. A serving gateway (SGW) 104 mainly provides the functions of a user plane, and the MME 103 and the SGW 104 may be in the same physical entity. A Packet Data Network Gateway (PGW) 105 is responsible for functions such as charging and legitimate listening, and it it is also possible for the PGW 105 to be in the same physical entity with the SGW 104. A Policy and Charging Rules Function entities (PCRF) 106 provides Quality of Service (QOS) and charging criteria. A general packet radio service support node (SGSN) 108 is a network node device for providing routing for transmission of data in the Universal Mobile Telecommunication System (UMTS). A home subscriber server (HSS) 109 is a home subsystem for a UE and is responsible for protecting user information such as current location of the user equipment, address of a serving node, user security information, and packet data context of user equipment.

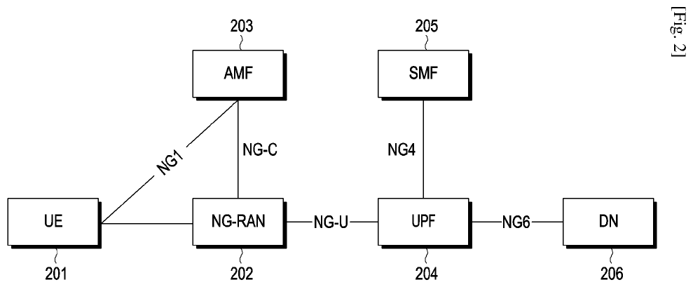

FIG. 2 is an exemplary system architecture 200 according to various embodiments of the present disclosure. Other embodiments of the system architecture 200 can be used without departing from the scope of the present disclosure.

A user equipment (UE) 201 is a terminal device used for receiving data. A Next-generation Radio Access Network (NG-RAN) 202 is radio access network in which base stations (gNBs or eNBs connected to 5G core networks, and the eNBs connected to 5GC are also termed ng-gNBs) for providing an access wireless network interface for a UE are included. An Access control and Mobility Management Function entity (AMF) 203 is responsible for managing UE's mobility context and the security information. A User Plane Function entity (UPF) 204 mainly provides the functions of a user plane. A Session Management Function entity (SMF) 205 is responsible for session management. A data network (DN) 206 includes for example services from the operator, access to the internet and third-party services.

Based on the development demands of the wireless technology, functional modules which used to be located in the same base station are separated in 5G architecture. Where some functional modules are increasingly approaching users, while other modules are pooled and virtualized for concentric deployment. That is, a base station may be divided into two parts: one part is a central unit (referred to simply as CU), and the other part is a distribute unit (referred to simply as DU). The DU is more closer to the user while the CU is far away from an antenna. Multi antenna conjunction is supported and network performance is improved. One CU may be connected to a plurality of DUs, and functions on the CU may be virtualized. The CU and the DU are connected via a F1 interface, and the F1 interface is also called a fronthaul interface or a fronthaul connection. Functions of Radio Resource Control (RRC) and Packet Data Convergence Protocol (PDCP) are implemented on the CU, and functions of Radio Link Control (RLC), Media Access Control (MAC) and physical layer are implemented on the DU.

In the specific embodiments below, technical solutions of the present application and how the above technical problems are solved by the technical solutions of the present application will be explained in detail. These specific embodiments below may be combined with each other, and the same or like concepts or procedures in certain embodiments may not be repeated. Hereinafter, embodiments of the disclosure will be described with reference to the accompanying drawings. The text and accompanying drawings described as follows are provided by way of example only to aid the reader in understanding the present disclosure. They are not intended to and should not be interpreted to limit the scope of the present disclosure in any way. While some embodiments and examples have been provided, based on the contents disclosed herein, it is obvious to a person skilled in the art that the embodiments and examples as shown may be altered without departing from the scope of the present disclosure.

With the development of networks, reforming and innovations in industries such as manufacturing industry, transportations, energy sources, common services and healthcare are facilitated by the connectivity and the mobility of mobile communication networks, there will be strong demands for wireless communications in vertical markets. These different vertical services have brought widespread performance requirements in terms of throughput, capacity, delay, mobility, reliability, and positioning accuracy. In order to provide transactions having different demands with quality of service (QOS) based on demands, network slices are introduced into mobile communication networks. A network slice is an end-to-end logical slice, and each of the slices has different QoSs and may provide services for different transactions and users. One of the important developing directions to enhance network slices is how to make better use of network slices and allocate reasonable resources for network slices, so as to guarantee the continuity of the service and the quality of service in the limited network resources available.

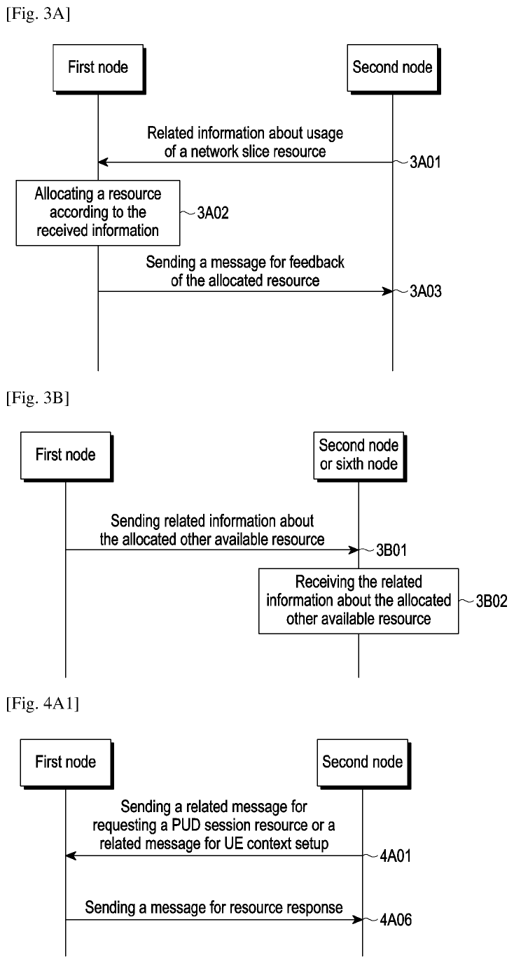

For the above problems, in order to achieve network slice enhancement so as to make better use of network resources and allocate reasonable resources for network slices, therefore guaranting the continuity of the service and the quality of service in the limited network resources available, an embodiment of the present application provides a session establishment and control method. In the method, improvements are made in three aspects including slice resource reselection, slice rate restriction, and a defect that network slices of a master node and a secondary node cannot be supported simultaneously in case of dual-connectivity. Hereinafter, the implementations of the method will be described in detail with reference to the FIGS. 3A through 8.

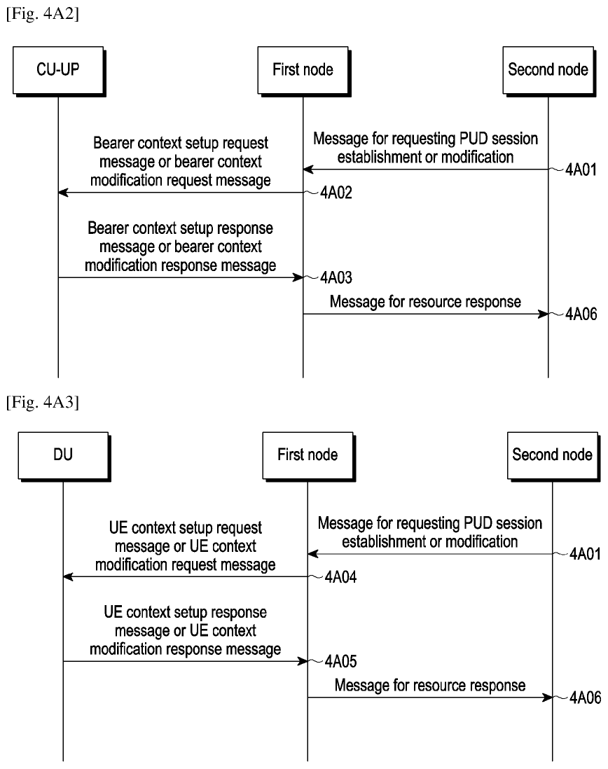

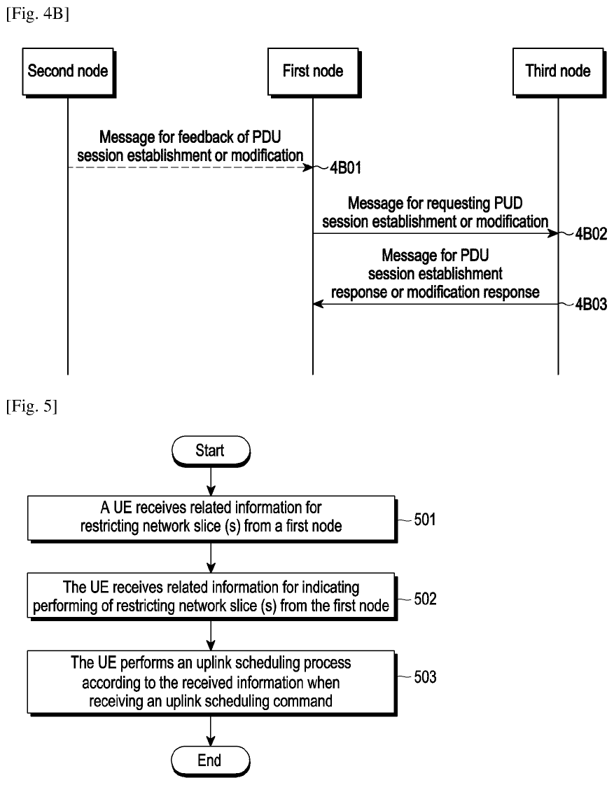

Firstly, a session establishment and control method provided by the present disclosure can solve the problem of slice resource reselection. Hereinafter, a session establishment and control method provided by the present disclosure will be described in detail with reference to the FIGS. 3A through 4B.

### Embodiment 1

There is shown an exemplary method for session establishment and control provided by the present disclosure in FIG. 3A. Detail explanations about steps having no correlations with the present disclosure are omitted herein. The method may include:

Step 3A01, in which receiving, by a first node, related information about usage of a network slice resource from a second node.

For example, the first node receives a related message for requesting a PDU (Protocol Data Unit or a Packet Data Unit) session resource or a related message for requesting UE context setup from a second node. If it is a related message for requesting UE context setup, related information about usage of a network slice resource is included in the related message. If it is a related message for requesting a PDU session resource, the requested PDU session resource may be a resource required for PDU session establishment or may be a resource required for PDU session modification. The Related message includes: Single Network Slice Selection Assistance Information (S-NSSAI) for a PDU session to be established or modified, and/or related information about usage of a network slice resource.

In embodiments of the present application, a PDU session refers to a logical channel for providing an end-to-end user plane connection between a UE and a data network. In embodiments of the present application, the PDU session includes at least one Qos flow, and the QoS flow may also refer to a bearer or logical channel.

Optionally, the related information about usage of a network slice resource may be at least one of the following items of information:
related information for restricting simultaneous use of network slices;
related information for restricting use time of a network slice;
related information for restricting use location of a network slice;
related information for restricting use frequency of a network slice;
related information on whether network slice resources can be pre-empted or not; and
related information on whether a dedicated network slice resource can be used or not.

Step 3A02, in which allocating, by a first node, a resource according to the received information.

Specifically, when the first node allocates a resource for a PDU session which is being requested to be established or resource is needed to be reallocated due to network slice overloading, the S-NSSAI in the message is taken into account. When the first node or the cells of the first node do not support the S-NSSAI or the network slice resource corresponding to the S-NSSAI is not available (for example, slice resource overloading or the resource being insufficient), the first node allocates other available resource for the PDU session by considering the related information about usage of a network slice resource.

For example, the first node may consider whether a resource corresponding to other S-NSSAI can be allocated or not according to the restriction information in the related information about usage of a network slice resource. If there are no resources corresponding to other S-NSSAI available, the first node may preempt resource corresponding to other S-NSSAI according to the related information on whether network slice resources can be pre-empted or not, or may decide whether a resource corresponding to a dedicated S-NSSAI can be used according to the related information on whether dedicated network slice resources can be used or not.

In this embodiment, allocating resources may be deemed as slice resource remapping.

In this embodiment, the first node may be a base station or a core network node or a distributed unit (DU) of a base station or a central unit-user plane (CU-UP) of a base station. The second node may be a core network node or a base station or a central unit (CU) or a central unit-control unit (CU-CP). The core network node may be a SMF or a AMF

As an example, depending on the specific implementations of the first node and the second node, the step of the first node receiving a message for requesting establishment and modification of a PDU session establishment may be implemented by any of the approaches below.

A base station serving as the first node receives the message from a core network node serving as the second node.

A second base station serving as the first node receives the message from a first base station serving as the second node. For example, the message is sent by a source base station to a target base station or is sent by a master base station to a secondary base station.

A second core network node serving as the first node receives the message from a first core network node serving as the second node. For example, the message is sent by a source core network node to a target core network node.

A core network node serving as the first node receives the message from a base station serving as the second node.

A DU serving as the first node receives the message from a CU serving as the second node.

A CU-UP serving as the first node receives the message from a CU-CP serving as the second node.

As an example, depending on the specific implementations of the first node and the second node, the message may be any of:
an initial UE context setup request message (in case that the first node is a base station and the second node is a core network node);
a PDU session resource setup request message (in case that the first node is a base station and the second node is a core network node);
a handover request message (in case that the first node is a target base station and the second node is a core network node, or the first node is a target base station and the second node is a source base station);
a secondary node addition request message (in case that the second node is a secondary base station and the first node is a master base station);
a handover required message (in case that the first node is a source core network node and a second node is a source base station);
a path handover request acknowledgement message (in case that the first node is a target base station and the second node is a core network node);
a UE context setup request message (in case that the first node is a target core network node and the second node is a source core network node);
a UE context setup request message or a UE context modification request message (in case that the first node is a DU and the second node is a CU); and
a bearer context setup request message or a bearer context modification request message (in case that the first node is a CU-UP and the second node is a CU-CP).

It should be understood that the above examples are only by way of example, and do not constitute a limitation to the embodiments of the present application.

Step 3A03, in which sending, by a first node, a message for feedback of the allocated resource to a second node.

Where the message for feedback of the allocated resource includes a resource allocated to a PDU session or to QoS flows in the PDU session. The resource may be other available resource. That is, when the requested PDU session resource is not supported or shortage, the first node may allocate other available resource for a PDU session or QoS flows in the PDU session by considering the related information about usage of a network slice resource to ensure the continuity of the service and the Quality of Service requirements.

With the forgoing session establishment and control method provided by the present disclosure, during the procedure of UE handover or session establishment, when the requested network slice resource is shortage or the network slice is not supported, in order to guarantee the continuity of the service and the QoS, the network may configure an ongoing session with the most suitable resource preferentially. When the most suitable resource is not available, UE can be served with best efforts. Meanwhile, the method can feed back a configuration result of the adjusted resource to the session initiating node, it is beneficial for the operator to make more flexible charging strategies, perform slicing or service resource optimization control as well as handover optimization or load balancing better.

### Embodiment 2

There is shown an exemplary method for session establishment and control provided by the present disclosure in FIG. 3B. Detail explanations about steps having no correlations with the present disclosure are omitted herein. The method may include:

At step 3B01, a first node sends related information about the allocated other available resource to a second node or a sixth node.

The related information about the allocated other available resource is related information about other available resource selected by the first node according to configurations (for example configuration information for usage of a network slice resource and/or slice mapping strategies etc.) and its own resource usage situation. The other available resource is not the requested resource in the requested PDU session. That is, the requested PDU session resource is A, but the first node cannot allocate the resource A to the PDU session according to configurations and its own resource usage situation. Therefore, a resource B is selected for being allocated to the PDU session.

Optionally, the related information about the allocated other available resource which is sent to the second node may be at least one of the following various items of information:
information for indicating a way of the PDU session or QoS flows in the PDU session being allocated with the other available resource;
information for indicating a S-NSSAI corresponding to the other available resource allocated to the PDU session or QoS flows in the PDU session;
information for indicating a resource type corresponding to the other available resource allocated to the PDU session or QoS flows in the PDU session;
information for indicating time information when the other available resource allocated to the PDU session or QoS flows in the PDU session is used;
information for indicating data amount when the other available resource allocated to the PDU session or QoS flows in the PDU session is used; and
information for indicating that the PDU session or QoS flows in the PDU session have been allocated with the other available resource.

The related information about the allocated other available resource which is sent to the sixth node may be at least one of the following various items of information:
statistical report information on usage of other available resource by a network slice; and
related information for indicating the status of other available resource being used.

As an example, the first node may be one of the following: a base station, a core network node, a DU of a base station, a CU-UP of a base station, and a CU-CP of a base station. The second node may be one of the following: a core network node, a base station, a CU of a base station, a CU-CP of a base station, a DU of a base station, and a CU-CP of a base station. The core network node may be a SMF or a AMF. The sixth node may be a base station. For example, when the first node is a base station, the sixth node is a base station adjacent to the first node.

Depending on the specific implementations of the first node and the second node, the step of the first node sending the information to the second node is implemented by any of the approaches below.

The information is sent by a base station serving as the first node to a core network node serving as the second node;

The information is sent by a second base station serving as the first node to a first base station serving as the second node; For example, the information is sent by a target base station to a source base station or by a secondary base station to a master base station;

The information is sent by a second core network node serving as the first node to a first core network node serving as the second node; for example, the information is sent by a target core network node to a source core network node;

The information is sent by a base station serving as the first node to a core network node serving as the second node;

The information is sent by a DU serving as the first node to a CU serving as the second node;

The information is sent by a CU-UP serving as the first node to a CU-CP serving as the second node;

The information is sent by a CU serving as the first node to a DU serving as the second node; and

The information is sent by a CU-CP serving as the first node to a CU-UP serving as the second node.

As an example, depending on the specific implementations of the first node and the second node, the message may be any of:
an initial UE context setup response message (in case that the first node is a base station and the second node is a core network node);
a PDU session resource establishment response message (in case that the first node is a base station and the second node is a core network node);
a handover request acknowledgement message (in case that the first node is a target base station and the second node is a core network node, or the first node is a target base station and the second node is a source base station);
a secondary node addition request acknowledgement message (in case that the second node is a secondary base station and the first node is a master base station);
a handover required acknowledgement message (in case that the first node is a source core network node and a second node is a source base station);
a path handover request message (in case that the first node is a target base station and the second node is a core network node);
a UE context setup response message (in case that the first node is a target core network node and the second node is a source core network node);
a UE context setup response message or a UE context modification response message (in case that the first node is a DU and the second node is a CU);
a bearer context setup response message or a bearer context modification response message (in case that the first node is a CU-UP and the second node is a CU-CP);
a UE context setup request message or a UE context modification request message (in case that the first node is a CU and the second node is a DU); and
a bearer context setup request message or bearer context modification request message (in case that the first node is a CU-CP and the second node CU-UP).

It should be understood that the above examples are only by way of example, and do not constitute a limitation to the embodiments of the present application.

At step 3B02, the second node receives the related information about the allocated other available resource.

As an example, depending on the specific implementations of the first node and the second node, one of the following schemes may be performed by the second node after receiving the related information about the allocated other available resource:

Scheme 1: if the second node is a CU and the first node is a DU or the second node is a CU-CP and the first node is a CU-UP, the second node receives the information and forwards the information to the core network node and other base stations, so that the core network node performs charging according to the situation of the usage of the resource or other base stations perform handover decision and optimization by considering the information.

Scheme 2: if the second node is a core network node, the core network node may perform charging by considering the information, for instance charging based on usage of the slice resource, but not limited thereto.

Scheme 3: if the second node is a base station, the base station takes the information into account, the information may be used by the following using methods.

First using method: to perform handover decision optimization, for instance, when the second node has a plurality of candidate target cells, a source cell may decide a target cell for the UE according to whether other resource is used by a target cell and type of other resource, but not limited thereto.

Second using method: to perform mobility robustness optimization, for instance, when a target cell applies slice resource remapping to a certain specific slice multiple times, the target cell may indicate to a source cell the related information about the slice resource remapping (e.g., the number and time of the slice resource remapping). The source cell may consider the information on the slice resource remapping while making handover decision so as to select the most suitable and best target cell for a UE.

Third using method: to perform load balancing, when two base station nodes exchange resource status information, a resource status corresponding to each of the network slices may be exchanged. If the resource of a network slice is used by other network slice, the use case of the resource of the network slice by the other network slice and the resource status may be transferred to the neighbor base station(s) together, so that the neighbor base station(s) to make better load balancing decision, providing best service for UE.

That is, if the second node is a DU or CU-UP, the DU and/or CU-UP needs to consider the information when performing the network slice rate enforcement. For example, the second node needs to know a S-NSSAI corresponding to other available resource allocated to a PDU session, in order to consider the limit on the maximum bite rate (MBR) corresponding to the S-NSSAI which corresponds to the other available resource when allocating resource and performing scheduling for DRB(s) or logical channel(s) corresponding to the PDU session. If the sum of the rates of all DRBs and logical channels corresponding to the S-NSSAI exceeds the MBR, the second node may perform admission control or rate control on services in the PDU session which uses the other available resource.

With the forgoing session establishment and control method provided by the present disclosure, during the procedure of UE handover or session establishment, when the requested network slice resource is shortage or the network slice is not supported, in order to guarantee the continuity of the service and the QoS, the network may configure an ongoing session with the most suitable resource preferentially. When the most suitable resource is not available, UE can be served with best efforts. Meanwhile, the method can feed back a configuration result of the adjusted resource to the session initiating node, it is beneficial for the operator to make more flexible charging strategies, perform slicing or service resource optimization control as well as handover optimization or load balancing better.

### Embodiment 3

There is shown an exemplary method for session establishment and control provided by the present disclosure in FIG. 4A1. Detail explanations about steps having no correlations with the present disclosure are omitted herein. The method may include:

At step 4A01, the second node sends a related message for requesting a PDU session resource or a related message for UE context setup to the first node. Where if it is a related message for requesting a PDU session resource, it may be a message for requesting PDU session establishment or modification.

The first node may be a base station, and the second node may be a core network node or a base station. For example, following several situations may be included.
1. If the first node is a base station while the second node is a core network node, the message may be a UE context setup request message or a handover request message;
2. If both of the first node and the second node are base stations, the message may be a handover request message sent by a source base station to a target base station or a secondary node addition message sent by a master base station to a secondary base station.

It should be understood that the above examples are only by way of example, and do not constitute a limitation to the embodiments of the present application. The related information about usage of a network slice resource may be included in the message.

Optionally, the information may be at least one of the following items of information:

1). related information for restricting simultaneous use of network slices.

For example, the related information may be a Network Slice Simultaneous Registration Group (NSSRG), and the Network Slice Simultaneous Registration Group is used for indicating whether network slices can be used simultaneously for a certain UE. If two network slices are not in the same NSSRG, it is indicated that these two network slices cannot be used simultaneously by the UE.

When one of the following conditions is satisfied, the first node considers the related information (e.g., NSSRG) for restricting simultaneous use of network slices to decide whether a resource corresponding to other S-NSSAI may be used by the PDU session.

Condition 1: when the first node intends to establish a PDU session requested by the UE, the S-NSSAI corresponding to the PDU session which is requested to be established is not supported by the first node, or, a network slice resource corresponding to the PDU session which is requested to be established is shortage;

Condition 2: a network slice resource corresponding to the PDU session which has been established is shortage.

The resource corresponding to other S-NSSAI which may be used and the network slice being used by the UE are in the same NSSRG.

For example, there are two requested PDU sessions, which are a PDU session 1 requesting to use a network slice 1 and a PDU session 2 requesting to use a network slice 2 respectively. When the network slice 1 is not supported by the first node or a resource corresponding to network slice 1 is shortage, the first node may consider selecting other network slice for providing to PDU session 1. For example, the first node may consider a resource corresponding to a network slice 3 while limitations on NSSRG should be considered at the same time. If the network slice 3 are not in the same NSSRG with network slices 1 or 2, it is indicated that the network slice 3 cannot be used with network slices 1 or 2 simultaneously, therefore the first node cannot allocate the resource corresponding to network slice 3 to the PDU session 1.

It should be understood that the above examples are only by way of example, and do not constitute a limitation to the embodiments of the present application.

2). related information for restricting use time of a network slice;

For example, the related information may be a network slice ID and a specific time or a time interval at which a network slice may be used or cannot be used. The network slice ID may be one or more S-NSSAIs, and the related information about time may be time information that the usage of a network slice is allowed or time information that the usage of a network slice is not allowed.

When one of the following conditions is satisfied, the first node may consider related information for restricting use time of a network slice while selecting other available resource. The first node may select a resource corresponding to other network slice which is allowed to be used at the current time, and does not select a resource corresponding to other network slice which is not allowed to be used at the current time.

Condition 1: when the first node intends to establish a PDU session requested by the UE, the S-NSSAI corresponding to the PDU session which is requested to be established is not supported by the first node, or, a network slice resource corresponding to the PDU session which is requested to be established is shortage;

Condition 2: a network slice resource corresponding to the PDU session which has been established is shortage.

3). related information for restricting use location of a network slice.

For example, the related information may be a network slice ID and related information about geographical locations which correspond to the ID and may be used or cannot be used. The network slice ID may be one or more S-NSSAIs, and the related information about geographical locations may be a cell list or tracking area list or a specific geographic coordinate area. The related information about the locations may be related information about geographical locations at which the usage of a network slice is allowed or related information about geographical locations at which the usage of a network slice is not allowed.

When one of the following conditions is satisfied, the first node may consider related information for restricting use location of a network slice while selecting other available resource. According to the current location of the UE, the first node may select a resource corresponding to other network slice which is allowed to be used or does not select resource corresponding to other network slice which is not allowed to be used.

Condition 1: when the first node intends to establish a PDU session requested by the UE, the S-NSSAI corresponding to the PDU session which is requested to be established is not supported by the first node, or, a network slice resource corresponding to the PDU session which is requested to be established is shortage;

Condition 2: a network slice resource corresponding to the PDU session which has been established is shortage.

4). related information for restricting use frequency of a network slice.

For example, the related information may be a network slice ID and related information about frequency which may be used or cannot be used. The network slice ID may be one or more S-NSSAIs, and the related information about frequency may be information about frequency which is allowed to be used or information about frequency which is not allowed to be used.

When one of the following conditions is satisfied, the first node considers related information for restricting use frequency of a network slice while selecting other available resource. The first node may select a frequency resource which is supported by the first node and/or a base station adjacent to the first node, select a frequency resource which is allowed to be used, or does not select a frequency resource which is not allowed to be used.

Condition 1: when the first node intends to establish a PDU session requested by the UE, the S-NSSAI corresponding to the PDU session which is requested to be established is not supported by the first node, or, a network slice resource corresponding to the PDU session which is requested to be established is shortage;

Condition 2: a network slice resource corresponding to the PDU session which has been established is shortage.

5). related information on whether network slice resources can be pre-empted or not.

For example, the related information may include a network slice ID such as S-NSSAI and at least one of the following items of information: priority of a resource corresponding to the S-NSSAI, whether the S-NSSAI can preempt other network slice resource or not, and whether resource corresponding to the S-NSSAI can be preempted by other network slice resource or not.

When a network slice is not supported by the first node or the resource thereof is shortage at the first node, the first node may decide whether the network slice can (or is allowed to) preempt other network slice resource according to information on whether the network slice can preempt other network slice resource. If the decision is YES (or be allowed), the first node proceeds to compare priority of resource corresponding to the network slice with priority of resource corresponding to other network slice, and then preempt resource corresponding to other network slice which has lower priority than the network slice based on the comparison result.

Or, when other network slice is intended to preempt the resource corresponding to the network slice, the first node needs to consider whether the network slice can be preempted by other network slice. If it is YES, the resource of the network slice may be preempted; and if it is NO, the resource corresponding to the network slice cannot be preempted.

6). related information on whether a dedicated network slice resource can be used or not.

For example, the related information may include at least one of the following items of information: whether a dedicated network slice resource can be used and usage limitations or not etc.

When one of the following conditions is satisfied, the first node considers whether the network slice can use a dedicated network slice resource while selecting other available resource. If it is YES, the dedicated network slice resource can be used; and if it is NOT, the dedicated network slice resource cannot be used. If there exists use time limit information, the dedicated network slice resource can be used with limitations such as time limit and quality (Qos) limitation.

Condition 1: when the first node intends to establish a PDU session requested by the UE, the S-NSSAI corresponding to the PDU session which is requested to be established is not supported by the first node, or, a network slice resource corresponding to the PDU session which is requested to be established is shortage;

Condition 2: a network slice resource corresponding to the PDU session which has been established is shortage.

That is, the first node receives related information about usage of a network slice resource, and when the network slice corresponding to the requested PDU session is not supported by the first node or the resource thereof is shortage at the first node, the first node may select other available resource for the PDU session. The first node may consider related information about usage of a network slice resource while selecting other available resource. If multiple items of information are included in the configuration information, these multiple items of information can be taken into account at the same time (for example, time limit and geographical restriction are considered simultaneously), or single item of information is considered separately.

It should be understood that the above examples are only by way of example, and do not constitute a limitation to the embodiments of the present application.

At step 4A06, the first node sends a message for resource response to the second node.

Where the message for resource response may include: a message for PDU session establishment response or a message for PDU session modification response.

The first node may be a base station, and the second node may be a core network node or a base station. For example, following several situations may be included.

1. If the first node is a base station and the second node is a core network node, the message may be PDU session establishment response message or path switch request message or data usage report message.

2. If both of the first node and the second node are base stations, the message may be a handover request acknowledgement message or a secondary node addition request acknowledgement message or data usage report message.

Optionally, the message may include related information about the allocated other available resource, the related information about the allocated other available resource may be at least one of the following various items of information:
information for indicating a way of the PDU session or QoS flows in the PDU session being allocated with the other available resource. For instance, it may be information such as carrier aggregation, multi RAT-dual links (MR-DC), slice remapping or slice resource remapping. Or, in more detail, it is information for indicating whether a dedicated resource is used or whether other network slice resource is preempted.
information for indicating a S-NSSAI corresponding to the other available resource allocated to the PDU session or QoS flows in the PDU session, may be one or more S-NSSAIs;
information for indicating a resource type corresponding to the other available resource allocated to the PDU session or QoS flows in the PDU session, the resource type may be physical layer resource (frequency resource), transmission resource and/or hardware resource, DRB resource, and/or number of users for a RRC connection;
information for indicating time information when the other available resource allocated to the PDU session or QoS flows in the PDU session is used, the time information may be a start and/or end time when the other available resource being used, or length of time of usage;
information for indicating data amount when the other available resource allocated to the PDU session or QoS flows in the PDU session is used, the data amount may be uplink or downlink data amount.
information for indicating statistical report on usage of other available resource by a certain network slice, for example, the number of times the other available resource being used, use time and/or data amount; and

related information for indicating the status of other available resource used, the information may be information such as a resource capacity being used by other network slice corresponding to each network slice or resource capacity proportion, and/or whether the resource used by the other network slice can be preempted or not, and/or time of usage of resource by the other network slice.

The second node receives the message for resource response. Depending on the specific implementations of the second node, one of the following schemes may be performed by the second node after receiving the message and the information:

1. If the second node is a core network node, the second node may perform charging on the UE according to the information. For example, charging is performed according to the using way of other resource and/or resource of other network slice being used (i.e., charging based on network slice), and/or based on the time of usage of the other resource, and/or based on data amount when the other resource is used.

2. If the second node is a base station, the second node may perform handover decision, handover optimization and/or load balancing according to the information, or forward the information to a core network node for charging.

1). If the information is used for handover decision (e.g., in CHO conditional handover) and there is a plurality of candidate target cells, the second node, which serves as the source base station in the handover, may select the most suitable target cell for the UE performing handover according to the feedback information such as using way of other resource and resource type.

2). If the information is used for handover optimization (e.g., mobility robustness optimization MRO), the second node may consider statistical report on usage of other available resource by a network slice when considering a candidate target cell or a target cell.

For example, when other UE intends to perform handover, according to a S-NSSAI corresponding to a PDU session requested by the UE, whether the S-NSSAI uses other available resource frequently or for a long time in neighbor base station(s) or a cell is checked. If the S-NSSAI uses the other available resource frequently or for a long time in the neighbor base station(s) or the cell, the second node may not select the cells on the neighbor base station(s) as a candidate cell or target cell. In this way, it can be guaranteed that the most suitable target cell is selected for the UE and continuous service is provided; meanwhile it is also possible to reduce unnecessary network signaling overhead.

3). If the information is used for load balancing, the second node may perform decision of load balancing better according to resource status use case corresponding to each network slice provided by neighbor base station(s), including the use case of resource corresponding to the network slice by other network slice, in order to provide best service for all users.

With the forgoing session establishment and control method provided by the present disclosure, during the procedure of UE handover or session establishment, when the requested network slice resource is shortage or the network slice is not supported, in order to guarantee the continuity of the service and the QoS, the network may configure an ongoing session with the most suitable resource preferentially. When the most suitable resource is not available, UE can be served with best efforts. Meanwhile, the method can feed back a configuration result of the adjusted resource to the session initiating node, it is beneficial for the operator to make more flexible charging strategies, perform slicing or service resource optimization control as well as handover optimization and load balancing better.

### Embodiment 4

There is shown an exemplary method for session establishment and control provided by the present disclosure in FIG. 4A2. Detail explanations about steps having no correlations with the present disclosure are omitted herein. The method may include:

At step 4A01, the second node sends a message for requesting PDU session establishment or modification to the first node.

At step 4A02, if the first node is a CU-CP under a separate architecture, the first node sends a bearer context setup request message or a bearer context modification request message to a CU-UP. The message includes related information about usage of a network slice resource. Regarding to the specific content included in the message, please refer to the step 4A01 in Embodiment 3, and it will not be repeated here.

The CU-UP receives the related information about usage of a network slice resource, and when a network slice corresponding to the requested PDU session is not supported by the first node or resource thereof is shortage on the CU-UP, the CU-UP may select other available resource for the PDU session. The CU-UP may consider the related information about usage of a network slice resource while selecting other available resource. If multiple items of information are included in the configuration information, these multiple items of information can be taken into account at the same time (for example, time limit and geographical restriction are considered simultaneously), or various items of information are considered separately.

It should be understood that the above examples are only by way of example, and do not constitute a limitation to the embodiments of the present application.

At step 4A03, the CU-UP sends a bearer context setup response message or a bearer context modification response message to the first node (i.e., CU-CP).

Optionally, the message may include related information about the allocated other available resource, the related information about the allocated other available resource may be at least one of the following various items of information:
information for indicating a way of the PDU session or QoS flows in the PDU session being allocated with the other available resource. For instance, it may be information such as slice remapping and slice resource remapping. Or, in more detail, it is information for indicating whether a dedicated resource is used or whether other network slice resource is preempted;
information for indicating a S-NSSAI corresponding to the other available resource allocated to the PDU session or QoS flows in the PDU session, may be one or more S-NSSAIs;
information for indicating a resource type corresponding to the other available resource allocated to the PDU session or QoS flows in the PDU session, the resource type may be transmission resource and/or hardware resource, DRB resource, and/or number of users for a RRC connection;
information for indicating time information when the other available resource allocated to the PDU session or QoS flows in the PDU session is used, the time information may be a start and/or end time when the other available resource being used, or length of time of usage;
information for indicating data amount when the other available resource allocated to the PDU session or QoS flows in the PDU session is used, the data amount may be uplink or downlink data amount; and
information for indicating statistical report on usage of other available resource by a certain network slice, for example, the number of times the other available resource being used, use time and/or data amount.

The first node (i.e., CU-CP) receives and save the response message, and may also further forward the response message to the second node (as shown in step 4A06) for use with functions such as handover decision, handover optimization and/or charging.

With the forgoing session establishment and control method provided by the present disclosure, during the procedure of UE handover or session establishment, when the requested network slice resource is shortage or the network slice is not supported, in order to guarantee the continuity of the service and the QoS, the network may configure an ongoing session with the most suitable resource preferentially. When the most suitable resource is not available, UE can be served with best efforts. Meanwhile, the method can feed back a configuration result of the adjusted resource to the session initiating node, it is beneficial for the operator to make more flexible charging strategies, perform slicing or service resource optimization control as well as handover optimization or load balancing better.

### Embodiment 5

There is shown an exemplary method for session establishment and control provided by the present disclosure in FIG. 4A3. Detail explanations about steps having no correlations with the present disclosure are omitted herein. The method may include:

At step 4A01, the second node sends a message for requesting PDU session establishment or modification to the first node.

At step 4A04, if the first node is a CU under a separate architecture, the first node sends a UE context setup request message or a UE context modification request message to a DU. The message includes related information about usage of a network slice resource. Regarding to the specific content included in the configuration information, please refer to the step 4A01 in Embodiment 3, and it will not be repeated here.

The DU receives the related information about usage of a network slice resource, and when a network slice corresponding to the requested PDU session is not supported by the first node or resource thereof is shortage on the DU, the DU may select other available resource for the PDU session. The DU may consider the related information about usage of a network slice resource while selecting other available resource. If multiple items of information are included in the configuration information, these multiple items of information can be taken into account at the same time (for example, time limit and geographical restriction are considered simultaneously), or various items of information are considered separately.

It should be understood that the above examples are only by way of example, and do not constitute a limitation to the embodiments of the present application.

At step 4A05, the DU sends a UE context setup response message or a UE context modification response message to the first node (i.e., CU).

Optionally, the message may include related information about the allocated other available resource, the related information about the allocated other available resource may be at least one of the following various items of information:
information for indicating a way of the PDU session or QoS flows in the PDU session being allocated with the other available resource. For instance, it may be information such as carrier aggregation, slice remapping and slice resource remapping. Or, in more detail, it is information for indicating whether a dedicated resource is used or whether other network slice resource is preempted.
information for indicating a S-NSSAI corresponding to the other available resource allocated to the PDU session or QoS flows in the PDU session, the S-NSSAI may be one or more S-NSSAIs;
information for indicating a resource type corresponding to the other available resource allocated to the PDU session or QoS flows in the PDU session, the resource type may be physical layer resource (frequency resource), transmission resource and/or hardware resource, DRB resource, and/or number of users for a RRC connection;
information for indicating time information when the other available resource allocated to the PDU session or QoS flows in the PDU session is used, the time information may be a start and/or end time when the other available resource being used, or length of time of usage;
information for indicating data amount when the other available resource allocated to the PDU session or QoS flows in the PDU session is used, the data amount may be uplink or downlink data amount; and
information for indicating statistical report on usage of other available resource by a certain network slice, for example, the number of times the other available resource being used, use time and/or data amount.

The first node (i.e., CU-CP) receives and save the response message, and may also further forward the response message to the second node (as shown in step 4A06) for use with functions such as handover decision, handover optimization and/or charging.

With the forgoing session establishment and control method provided by the present disclosure, during the procedure of UE handover or session establishment, when the requested network slice resource is shortage or the network slice is not supported, in order to guarantee the continuity of the service and the QoS, the network may configure an ongoing session with the most suitable resource preferentially. When the most suitable resource is not available, UE can be served with best efforts. Meanwhile, the method can feed back a configuration result of the adjusted resource to the session initiating node, it is beneficial for the operator to make more flexible charging strategies, perform slicing or service resource optimization control as well as handover optimization or load balancing better.

### Embodiment 6

There is shown an exemplary method for session establishment and control provided by the present disclosure in FIG. 4B. Detail explanations about steps having no correlations with the present disclosure are omitted herein. The method may include:

At step 4B01, when PDU session establishment is performed or after the establishment, since a network slice resource corresponding to the PDU session is shortage or not supported, the first node selects other available resource for the PDU session (as shown in step 4A01), or the first node receives related information about other available resource selected for the PDU session from the second node (for example, CU-CP receives the related information from the DU/CU-UP) (as shown in steps 4A02 through 4A05), wherein the other available resource may be resource corresponding to other network slices. The other available resource may be included in the related message for response of PDU session resource for transmission.

The first node may be a CU or a CU-CP, and the second node may be a DU or a CUUP. That is, possible cases are as follows:

Case 1: The CU-CP serving as the first node receives related information about other available resource selected for the PDU session from the DU serving as the second node, and the information is transferred by the UE context setup response message or the UE context modification response message;

Case 2: The CU-CP serving as the first node receives related information about other available resource selected for the PDU session from the CU-UP serving as the second node, and the message is transferred by the bearer context setup response message or the bearer context modification response message.

At step 4B02, the first node sends a message used for PDU session establishment request or modification request to the third node. The third node may be a CU-UP or a DU. That is, possible cases are as follows:

Case 1: The CU-CP serving as the first node receives related information about other available resource selected for the PDU session from the DU serving as the second node and sends the message to the CU-UP serving as the third node. The message is a bearer setup context request message or a bearer context modification request message.

Case 2: The CU-CP serving as the first node receives related information about other available resource selected for the PDU session from the CU-UP serving as the second node and sends the message to the DU serving as the third node. The message is a UE context setup request message or a UE context modification request message.

The message includes related information about other available resource, and the information may indicate a S-NSSAI corresponding to the other available resource allocated to the PDU session and may be one or more S-NSSAIs. If it is the case of a plurality of S-NSSAIs, i.e., different DRBs under the PDU session use other available resources corresponding to different S-NSSAIs, there two cases for the content which may be included in the message:

Case A: One PDU session ID and a S-NSSAI corresponding to one other available resource;

Case B: A plurality of DRBs are included in a PDU session ID, and one DRB ID and a S-NSSAI corresponding to one other available resource are included in each DRB ID.

The third node needs to consider related information about other available resource included in the message when performing the network slice rate enforcement. For example, the third node needs to know a S-NSSAI corresponding to other available resource allocated to a PDU session or different DRBs in the PDU, in order to consider the limit on the maximum bite rate (MBR) corresponding to the S-NSSAI which corresponds to the other available resource when allocating resource and performing scheduling for a DRB or logical channel corresponding to the PDU session. If the sum of the rates of all DRBs and logical channels corresponding to the S-NSSAI exceeds the MBR, the third node may perform admission control or rate control on services in the PDU session which uses the other available resource.

At step 4B03, the third node sends a message used for PDU session establishment response or modification response to the first node.

With the forgoing session establishment and control method provided by the present disclosure, during the procedure of UE handover or session establishment, when the requested network slice resource is shortage or the network slice is not supported, in order to guarantee the continuity of the service and the QoS, the network may configure an ongoing session with the most suitable resource preferentially. When the most suitable resource is not available, UE can be served with best efforts. Meanwhile, the method can feed back a configuration result of the adjusted resource to the session initiating node, it is beneficial for the operator to make more flexible charging strategies, perform slicing or service resource optimization control as well as handover optimization or load balancing better.

### Embodiment 7

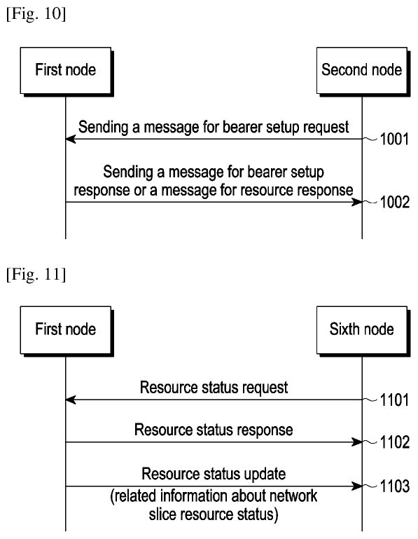

There is shown an exemplary method for session establishment and control provided by the present disclosure in FIG. 10. Detail explanations about steps having no correlations with the present disclosure are omitted herein. The method may include:

At step 1001, the second node sends a first message to the first node.

The first message is related to a UE context setup or modification request or a bearer setup or modification request. The second node is a core network node or a CU or CU-CP in a base station, the core network node may be a AMF or SMF, and the first node may be a base station or a DU or CU-UP in the base station.

In one embodiment, in case that the second node is a core network node and the first node is the base station, the first message may be a PDU session resource setup request message or a PDU session resource modification request message.

In another embodiment, in case that the second node is a CU or CU-CP in a base station and the first node is a DU in a base station, the first message may be a UE context setup request message or a UE context modification request message.

In another embodiment, in case that the second node is a CU-CP in a base station and the first node is a CU-UP in a base station, the first message may be a bearer context setup request or a bearer context modification request.

In another embodiment, in case that the second node is a source base station in a handover procedure and the first node is the target base station in a handover procedure, the first message may be a handover request message.

In another embodiment, in case that the second node is a master base station in a dual-connectivity or multi-connectivity scenario and the first node is a secondary base station in a dual-connectivity or multi-connectivity scenario, the first message may be a secondary node addition request message.

In another embodiment, in case that the second node is a last serving base station when the UE enters an INACTIVE state and the first node is a new serving base station accessed by a UE when the UE transitions from an INACTIVE state to an ACTIVE state, the first message may be a retrieve UE context response message.

It should be appreciated that the above embodiments are only by way of example, and that the second node, the first node and the first message are not limited thereto. In embodiments of the present application, a bearer may also be referred to as a QoS flow or logical channel.

The first message may include an establishment or modification request for a PDU session, and the requested PDU session includes an establishment or modification request for one or multiple QoS flows.

When one of the following conditions is satisfied, the first node takes QoS related information about QoS flows in a PDU session and/or information described in steps 4A01/4A02/4A04 into consideration, to decide whether other available resource can be used by the QoS flows.

In one embodiment, the other available resource refers to a resource corresponding to other network slice different from the requested network slice resource. It should be appreciated that the above embodiments are only by way of example, and that the type of the other available resource are not limited thereto.

Condition 1: when the first node intends to establish a PDU session requested by the UE, a network slice corresponding to the PDU session which is requested to be established is not supported by the first node, or, a network slice resource corresponding to the PDU session which is requested to be established is shortage;

Condition 2: a network slice resource corresponding to the PDU session which has been established is shortage.

At step 1002, the first node sends a second message to the second node. The second message is related to UE context setup or modification response and bearer setup or modification response, or, the second message is a message for resource response.

If the second message is related to UE context setup or modification response and bearer setup or modification response, according to one embodiment, in case that the second node is a core network node and the first node is a base station, the second message may be a PDU session resource establishment response message or a PDU session resource modification response message.

In another embodiment, in case that the second node is a CU or CU-CP in a base station and the first node is a DU in a base station, the second message may be one of the following: a UE context setup failure message, a UE context setup response message, a UE context modification response message, and a UE context modification failure message.

In another embodiment, in case that the second node is a CU-CP in a base station and the first node is a CU-UP in a base station, the second message may be one of the following: a bearer setup failure message, a bearer setup response message, a bearer modification failure message and bearer modification response message.

In another embodiment, in case that the second node is a source base station in a handover procedure and the first node is a target base station in a handover procedure, the second message may be a handover request acknowledgement or a handover failure message.

In another embodiment, in case that the second node is a master base station in a dual-connectivity or multi-connectivity scenario and the first node is a secondary base station in a dual-connectivity or multi-connectivity scenario, the second message may be a secondary node addition request message.

It should be appreciated that the above embodiments are only by way of example, and that the second node, the first node and second message are not limited thereto.

If the second message is a message for resource response which is the same as the description of step 4A06, and it will not be repeated here.

Optionally, the second message may include related information about the allocated other available resource, and the related information about the allocated other available resource may include information described in step 4A03, step 4A05 or step 4A06, and may also include information for indicating that the PDU session or QoS flows in the PDU session have been allocated with the other available resource.

In one embodiment, the information for indicating that the PDU session or QoS flows in the PDU session have been allocated with the other available resource is an explicit indication to indicate to the second node that the PDU session or QoS flows in the PDU session have been allocated with the other available resource. The explicit indication may be for each PDU session, or may also be for each QoS flow.

In another embodiment, as for information of the other available resource in the information for indicating that the PDU session or QoS flows in the PDU session have been allocated with the other available resource, it may be information for indicating which of the other available resources are allocated to the PDU session or QoS flows in the PDU session, e.g., the PDU session or QoS flows in the PDU session are allocated with resources corresponding to other network slices. The information may be for each PDU session and may also be for each QoS flow.

It should be appreciated that the above embodiments are only by way of example, and that information for indicating that the PDU session or QoS flows in the PDU session have been allocated with the other available resource is not limited thereto.

The second node receives the second message. Depending on the specific implementations of the second node, one of the following schemes may be performed by the second node after receiving the message and the information:

1. If the second node is a core network node, the second node may perform charging on the UE according to the information. For example, charging is performed according to the using way of other resource and/or resource of other network slice being used (i.e., charging based on network slice), and/or based on the time of usage of the other resource, and/or based on data amount when the other resource is used.

2. If the second node is a base station, the second node may perform handover decision, handover optimization and/or load balancing according to the information, or forward the information to a core network node for charging.

1). If the information is used for handover decision (e.g., in CHO conditional handover) and there is a plurality of candidate target cells, the second node, which serves as the source base station in the handover, may select the most suitable target cell for the UE performing handover according to the feedback information such as using way of other resource and resource type.

2). If the information is used for handover optimization (e.g., mobility robustness optimization MRO), the second node may consider statistical report on usage of other available resource by a network slice when considering a candidate target cell or a target cell.

For example, when other UE intends to perform handover, according to a S-NSSAI corresponding to a PDU session requested by the UE, whether the S-NSSAI uses other available resource frequently or for a long time in neighbor base station(s) or a cell is checked. If the S-NSSAI uses the other available resource frequently or for a long time in the neighbor base station(s) or the cell, the second node may not select the cells on the neighbor base station(s) as a candidate cell or target cell. In this way, it can be guaranteed that the most suitable target cell is selected for the UE and continuous service is provided; meanwhile it is also possible to reduce unnecessary network signaling overhead.

3). If the information is used for load balancing, the second node may perform decision of load balancing better according to resource status use case corresponding to each network slice provided by neighbor base station(s), including the use case of resource corresponding to the network slice by other network slice, in order to provide best service for all users.

With the forgoing session establishment and control method provided by the present disclosure, during the procedure of UE handover or session establishment, when the requested network slice resource is shortage or the network slice is not supported, in order to guarantee the continuity of the service and the QoS, the network may configure an ongoing session with the most suitable resource preferentially. When the most suitable resource is not available, UE can be served with best efforts. Meanwhile, the method can feed back a configuration result of the adjusted resource to the session initiating node, it is beneficial for the operator to make more flexible charging strategies, perform slicing or service resource optimization control as well as handover optimization and load balancing better.

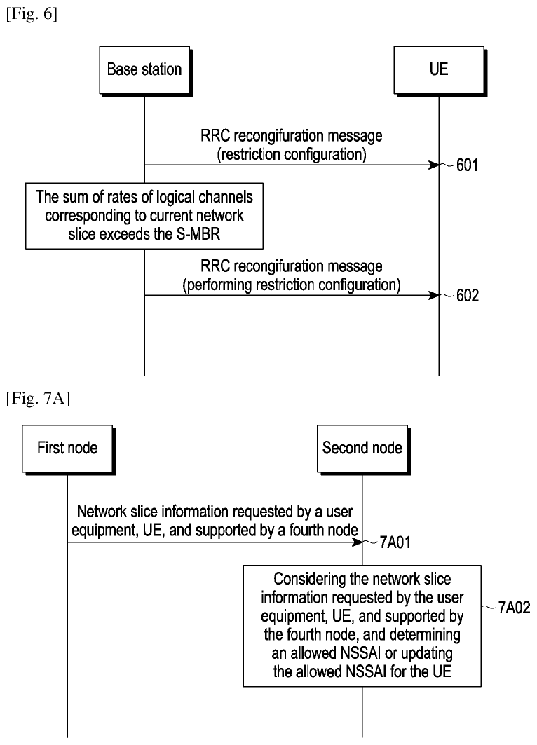

Secondly, a session establishment and control method provided by the present disclosure can solve the problem of slice rate limiting. Hereinafter, a session establishment and control method provided by the present disclosure will be described in detail with reference FIG. 5 and FIG. 6.

### Embodiment 8

There is shown an exemplary method for session establishment and control provided by the present disclosure in FIG. 5. Detail explanations about steps having no correlations with the present disclosure are omitted herein. The method may include:

At step 501, a UE receives related information for restricting network slice(s) from a first node. The related information for restricting network slice(s) is intended to limit the sum of the rates of services on a specific network slice not to exceed a given slice-maximum bite rate.

The first node may be a base station or a core network node. If the first node is a base station, the related information for restricting network slice(s) is sent to the UE by the base station via a RRC message (e.g., RRC reconfiguration message) or MAC layer signaling (e.g., downlink control indication (DCI)).

At step 502, the UE receives related information for indicating performing of restricting network slice(s) from the first node. The information is used for indicating how to use or how to execute the related information for restricting network slice(s) received in step 501.

The first node may be a base station or a core network node. If the first node is a base station, the information may be transferred through MAC layer signaling (e.g., DCI) or RRC layer signaling (a RRC message, e.g., a RRC reconfiguration message).

As an example, when the base station finds that the sum of rates of logical channels corresponding to current network slice exceeds the given slice-maximum bite rate or when the base station finds that the sum of rates of logical channels corresponding to a network slice is lower than the given slice-maximum bite rate, the base station sends to the UE related information for indicating performing of restricting network slice(s) rate. The above is only by way of example and is not intended to be limiting.

At step 503, the UE performs an uplink scheduling process according to the received information when receiving an uplink scheduling command.

As an example, when the UE receives uplink scheduling signaling from the base station, the UE obtains related configuration for restricting network slice rate used in this scheduling according to the related information for restricting network slice(s)received in step 501 and the related information for indicating performing of restricting network slice(s) received in step 502. Further, by considering the related configuration for restricting network slice rate used in this scheduling, the UE multiplexes logical channels satisfying a condition into a transport block of this scheduling according to the related configuration. Or, the UE will not multiplex logical channels not satisfying a condition into a transport block of this scheduling. In this way, it can be ensured that the sum of the rates on the logical channels corresponding to a network slice will not exceed the maximum bite rate.

With the forgoing session establishment and control method provided by the present disclosure, it is possible for the operator to control services or rates of network slices more effectively, so that the operator provides users with services more flexibly and performs charging more flexibly.

### Embodiment 9

The method shown in FIG. 5 is description having a user equipment as a performing entity. Hereinafter, a method provided by an embodiment of the present application is described when the first node is a base station and is taken as a performing entity. It may be understood that essential contents of the methods are the same irrespective of whether description is made from viewpoints of a base station or a user equipment. The method performed by the base station corresponds to the method performed by the user equipment.

There is shown an exemplary method for session establishment and control provided by the present disclosure in FIG. 6. Detail explanations about steps having no correlations with the present disclosure are omitted herein. The method may include:

At step 601, during the procedure of establishment of a PDU session, a base station sends a RRC reconfiguration message to a UE. The message includes related information about uplink logical channel establishment, and each of the uplink logical channels include related configuration information for restricting network slice(s) (referred to simply as “restriction configuration” hereafter). The related configuration information for restricting network slice(s) is intended to limit the sum of the rates of services on a specific network slice not to exceed a given slice-maximum bite rate. The given slice-maximum bite rate (S-MBR) may be from a core network node or a base station. Depending various methods for S-MBR execution (S-MBR enforcement), items of related configuration information for restricting network slice(s) which are received by the UE are also different. The following two methods can be used:

Method 1: The base station implements uplink S-MBR enforcement with restriction rules based on scheduling. The related configuration information for restricting network slice(s) includes restriction rules for restricting network slice scheduling (“referred to simply as “restriction rules” hereafter”). The restriction rule may be a mapping relationship between a logical channel ID (LCID) and a restriction index. That is, each of the logical channels corresponds to one restriction index, and the restriction indexes of different logical channels may be the same or different. Whether the restriction indexes are the same or different is dependent on whether the same network slice resource is used by logical channels. If it is YES, the restriction indexes are the same; and if it is NOT, the restriction indexes are different.

Method 1: The base station implements uplink S-MBR enforcement with a scheduling weight configuration. The related configuration information for restricting network slice(s) includes a configuration list for scheduling weights. The configuration list may be a configuration profile list corresponding to the LCID. The configuration profile list includes multiple configuration profiles. Where each of the configuration profiles include a configuration profile index and/or a priority processing weight. The priority processing weight may be a scheduling priority weight and/or a Priority Bit Rate (PBR) weight. That is, each of the configuration profiles corresponds to one of priority processing weight or Priority Bit Rate weight.

At step 602, a decision is made by a base station as to whether the sum of rates of logical channels corresponding to current network slice exceeds the given S-MBR for a network slice. When the base station finds that the sum of rates of logical channels corresponding to current network slice exceeds the given S-MBR or when the base station finds that the sum of rates of logical channels corresponding to current network slice does not exceed the given S-MBR, i.e., when the base station needs to change the scheduling of the logical channels, the base station will generate related information for indicating performing of restricting network slice(s) (referred to simply as “performing restriction information”) and send the performing restriction information to the UE. The performing restriction information may be transferred through MAC layer signaling (e.g., DCI) or a RRC message (e.g., RRC reconfiguration message).

The UE receives the performing restriction information, and selects restriction configurations used for this scheduling and the future scheduling according to the performing restriction information. When the UE receives an uplink scheduling command (e.g., uplink scheduling grant) from the base station, by considering the restriction configurations used, the UE multiplexes service data which needs to be scheduled into corresponding uplink resource.

According to the methods described in the step 601, there are several specific cases for implementation of S-MBR as follows:

Case 1: If the method 1 is used, what is received by the UE in step 601 is the restriction rules. Before every scheduling, the base station checks whether rates for network slices and/or all the logical channels corresponding to the network slices which have been scheduled exceed or are about to exceed the corresponding S-MBR. If it is YES, the base station may include the performing restriction information in this scheduling signaling. The performing restriction information includes information for indicating that the related information for performing of restricting network slice(s) is a restriction index, e.g., it may be a restriction index of a logical channel corresponding to the network slice.

That is, when the UE performs uplink scheduling priority processing every time, UE checks whether a restriction index is included in the scheduling signaling. If it is YES, the UE will not multiplex the logical channel corresponding to the restriction index into a transport block of this scheduling, i.e., the logical channel will not be scheduled in this scheduling, in order to ensure that the sum of the rates on logical channels corresponding to the network slices will not exceed the given slice-maximum bite rate after this scheduling.

Case 2: If the method 2 is used, what is received by the UE in step 601 is the configuration list for setting scheduling priority weights. Before every scheduling, the base station checks whether rates for network slice and/or all the logical channels corresponding to schedule network slice which have been scheduled exceed or are about to exceed the corresponding maximum rate value. If it is YES, the base station may include the performing restriction information in this scheduling signaling. The performing restriction information is information for indicating that the related information for performing of restricting network slice(s) is a configuration profile index for scheduling weights. The index corresponds to one of the priority processing weights. For example, it may be a scheduling priority weight and/or a Priority Bit Rate weight.

That is, based on a configuration profile index and the scheduling priority weight configuration corresponding to the index, UE considers the scheduling processing weight when performing uplink priority processing, so that the scheduling priority of the logical channel is lowered and/or the PBR is lowered, in order to ensure that the sum of the rates on logical channels corresponding to the network slices will not exceed the given slice-maximum bite rate after this scheduling.

With the forgoing session establishment and control method provided by the present disclosure, it is possible for the operator to control services or rates of network slices more effectively, so that the operator provides users with services more flexibly and performs charging more flexibly.

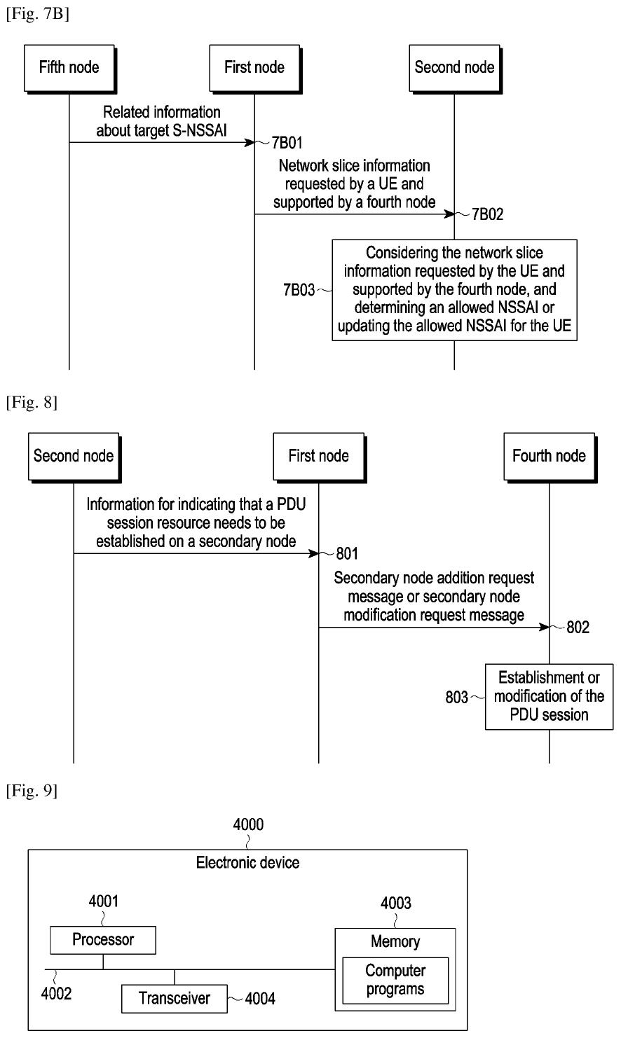

Lastly, a session establishment and control method provided by the present disclosure can also solve the problem that network slices of a master node and a secondary node cannot be supported simultaneously in case of dual connectivity. Hereinafter, a session establishment and control method provided by the present disclosure will be described in detail with reference to the FIGS. 7A through 8.

### Embodiment 10

There is shown an exemplary method for session establishment and control provided by the present disclosure in FIG. 7A. Detail explanations about steps having no correlations with the present disclosure are omitted herein. The method may include:

At step 7A01, a second node receives network slice information requested by a user equipment, UE, and supported by a fourth node which is sent by a first node, wherein the network slice information requested by the UE and supported by the fourth node is associated with the UE, and wherein requested by the UE means that the network slice information has been requested by the UE but been rejected, or, the network slice information that the UE intends to request. The network slice information requested by the UE and supported by the fourth node refers to an intersection of the network slice information requested by the UE and the network slice information supported by the fourth node. That is, the network slice information is requested by the UE and is also supported by the fourth node.

Optionally, prior to step 7A01, the first node may determine related information about network slice requested by the user equipment, UE, and supported by the fourth node according to related information about Target NSSAI, related information about allowed NSSAI, measurement reports from the UE, and/or the network slice information supported by the fourth node.

The related information about the Target NSSAI includes one or more S-NSSAIs which are not supported in the UE's current tracking area (TA), but the S-NSSAIs are supported by other TAs.

The first node is a base station serving the UE and is connected with the second node via UE associated signaling. The second node is a core network node, and the core network node is an AMF or a NSSF. The fourth node may be a neighboring node (e.g., an neighbor base station(s)) with respect to the first node or may be a secondary node (e.g., secondary base station) serving the UE under dual-connectivity or multi-connectivity.

Network slice information requested by the UE and supported by the fourth node refers to related information about a network slice requested by the UE and supported by nodes other than the first node, and a network slice requested by the UE and supported by the fourth node refers to a network slice which has been requested or is being requested by the UE, and is not included in the current allowed NSSAI, but is supported by the other nodes.

The network slice information supported by the fourth node may be transferred via a UE associated NGAP message, e.g., an initial UE message and a path switch request message etc.

At step 7A02, the second node considers the network slice information requested by the user equipment, UE, and supported by the fourth node, and determines an allowed NSSAI for the UE, or updates the allowed NSSAI for the UE, and sends the allowed NSSAI to the first node and the UE. When there is a service being initiated, the UE selects one S-NSSAI from the allowed NSSAI according to local configurations and network slice selection policies to initiate a PDU session connection establishment request to a network.

When the first node and other nodes have the same geographical coverage area, the other nodes may be secondary nodes serving the UE or have been secondary nodes serving the UE. With the method, when the first node and the other nodes support different network slices, it is possible for the second node to obtain network slice information that can be used by the UE in the geographical coverage area. That is, the UE can use network slices supported by the first node and the other nodes simultaneously.

With the forgoing session establishment and control method provided by the present disclosure, it is possible for the UE to use services provided by all available network slices with the UE being in coverage of a plurality of nodes having different network slice supporting capabilities. Even for network slices not supported by a serving base station but supported by neighbor base station(s), the UE may also use the network slices supported by the other base stations by means of secondary node addition approach. In this way, the deployment of networks is more flexible, service resource is provided in a much more comprehensive manner, and increase of diversified services provided by the operator anytime and anywhere is facilitated, therefor increasing the income of the operator.

### Embodiment 11

There is shown an exemplary method for session establishment and control provided by the present disclosure in FIG. 7B. Detail explanations about steps having no correlations with the present disclosure are omitted herein. The method may include:

At step 7B01, a first node obtains related information about Target S-NSSAI from a fifth node.

By way of example, the first node and the fifth node may be base stations, wherein if the fifth node is a source base station in a handover procedure, the first node is a target base station in the handover procedure. The Information may be transferred via a handover request message sent by the fifth node to the first node.

At step 7B02, the first node sends related information about a network slice requested by a UE and supported by a fourth node to the second node.

The first node may determine related information about network slice requested by the user equipment, UE, and supported by the fourth node according to related information about Target NSSAI, related information about allowed NSSAI, measurement reports from the UE, and/or the network slice information supported by the fourth node.

The related information about the Target NSSAI includes one or more of S-NSSAIs which are not supported in the UE's current tracking area (TA), but the S-NSSAIs are supported by other TAs.

The first node is a base station serving the UE and is connected with the second node via signaling associated with the UE. The second node is a core network node, and the core network node is an AMF or a NSSF. The fourth node may be a neighboring node (e.g., an neighbor base station(s)) with respect to the first node or may be a secondary node (e.g., secondary base station) serving the UE under dual-connectivity or multi-connectivity.

Network slice information supported by the fourth node refers to related information about a network slice supported by nodes other than the first node, and a network slice supported by the fourth node refers to a network slice which has been requested or being requested by the UE, and is not included in the current allowed NSSAI, but is supported by the other nodes.

The network slice information requested by the UE and supported by the fourth node may be transferred via a UE associated NGAP message, e.g., an initial UE message and a path switch request message etc.

At step 7B03, the second node receives and considers the obtained related network slice information requested by the UE and supported by the fourth node, and determines an allowed NSSAI for the UE, or updates the allowed NSSAI for the UE, and sends the allowed NSSAI to the first node and the UE.

When there is a service being initiated, the UE selects one S-NSSAI from the allowed NSSAI according to local configurations and network slice selection policies to initiate a PDU session connection establishment request to a network.

During a handover procedure, when the first node and other nodes have the same geographical coverage area, the other nodes may be secondary node(s) serving the UE or have been secondary node(s) serving the UE. With the method, when the first node and the other nodes support different network slices, it is possible for the second node to obtain network slice information that can be used by the UE in the geographical coverage area. That is, the UE can use network slices supported by the first node and the other nodes simultaneously.

With the forgoing session establishment and control method provided by the present disclosure, it is possible for the UE to use services provided by all available network slices with the UE being in coverage of a plurality of nodes having different network slice supporting capabilities. Even for network slices not supported by a base station serving the UE but supported by neighbor base station(s), the UE may also use the network slices supported by the other base stations by means of secondary node addition approach. In this way, the deployment of networks is more flexible, service resource is provided in a much more comprehensive manner, and increase of diversified services provided by the operator anytime and anywhere is facilitated, therefor increasing the income of the operator.

### Embodiment 12

There is shown an exemplary method for session establishment and control provided by the present disclosure in FIG. 8. Detail explanations about steps having no correlations with the present disclosure are omitted herein. The method may include:

At step 801, a first node receives information for indicating that a PDU session resource needs to be established on a secondary node from the second node.

The first node may be a base station and the second node may be a core network node. The information is transferred by a message related to PDU session establishment or modification, e.g., an initial context setup request message, a UE context modification request message, a PDU session resource setup request message or PDU session resource modification request message. The above is only by way of example and is not intended to be limiting.

At Step 802, the first node sends to a fourth node a secondary node addition request message or a secondary node modification request message, in which related information about PDU session establishment or modification requested in step 801 is carried.

The fourth node may be a base station, and the fourth node is a neighbor base station(s) with respect the first node or a secondary base station. The fourth node is selected according to the information for indicating that a PDU session resource needs to be established on a secondary node.

For example, the first node may determine the fourth node according to information for indicating that a PDU session resource needs to be established on a secondary node, measurement reports of the UE, and/or network slice information supported by a neighbor base station(s) etc.

By way of example, after receiving information for indicating that a PDU session resource needs to be established on a secondary node, the first node finds out neighbor base station(s) supporting the network slice according to the information and/or network slice information supported by the neighbor base station(s). The neighbor base station(s) may be one or more. According to measurement reports of the UE, the first node may select an appropriate base station from one or more neighbor base station(s)s satisfying a condition as a secondary node serving the UE, and establish the requested PDU session or modify the PDU session on the secondary node.

With the forgoing session establishment and control method provided by the present disclosure, it is possible for the UE to use services provided by all available network slices with the UE being in coverage of a plurality of nodes having different network slice supporting capabilities. Even for network slices not supported by a base station serving the UE but supported by neighbor base station(s), the UE may also use the network slices supported by the other base stations by means of secondary node addition approach. In this way, the deployment of networks is more flexible, service resource is provided in a much more comprehensive way, and increase of diversified services provided by the operator anytime and anywhere is facilitated, therefor increasing the income of the operator.

### Embodiment 13

There is shown an exemplary method for session establishment and control provided by the present disclosure in FIG. 11. Detail explanations about steps having no correlations with the present disclosure are omitted herein. The method may include:

At step 1101, a first node receives a resource status request message from a sixth node.

In particular, in this embodiment, the first node may be a base station or CU-UP, and the sixth node may be a base station or CU-CP. According to one embodiment, the first node and the sixth node are base stations, and the first node and the sixth node are neighbor base station(s)s; According to another embodiment, the first node is CU-UP, and the sixth node is CU-CP.

It is to be understood that the above is only by way of example, and that the first node and the sixth node are not limited thereto. The message may include the requested network slice information, and the requested network slice information may be one or more S-NSSAIs.

At step 1102, if the first node supports the requested resource status information (e.g., performs measurements on resource status related to the requested network slice), the first node sends resource status response to the sixth node.

In particular, in this embodiment, the first node considers the information, performs measurements on resource status related to the requested network slice, and includes the measurement results in a resource status update message sent by the first node to the sixth node.

At step 1103, the first node sends a resource status update message to the sixth node.

In particular, in this embodiment, the resource status update message includes measurement results obtained in step 1102, and the measurement results include related information about a network slice resource status.

According to one embodiment, the related information about a network slice resource status includes at least one of the following:
network slice ID, may be, for example, a S-NSSAI, for indicating the resource status of which network slice is measured;
information for indicating number of users for RRC connection for a network slice; the information for indicating number of users for RRC connection for a network slice refers to number of users for RRC connection available for the network slice in a first node, or number of users for RRC connection that have been used by the network slice; and the information may be a percentage or a specific numeric value; and
information for indicating usage of DRBs by a network slice; the information for indicating usage of DRBs by a network slice refers to number of DRBs available for the network slice in a first node, or number of DRBs that have been used by the network slice; and the information may be a percentage or a specific numeric value.

In particular, in this embodiment, a sixth node receives the information and the message. By considering related information about a network slice resource status, the sixth node selects an appropriate target cell for a UE in handover procedure or selects an appropriate secondary cell for a UE in dual connectivity scenario.

Depending on the specific implementations of the sixth node, one of the following schemes may be performed by the sixth node after receiving the message and the information:

1. When a UE handover is performed under the sixth node serving as a base station, the sixth node decides whether to select a cell under the first node as a target cell or candidate cell for handover for the UE by considering related information about a network slice resource status from the first node and the network slice information requested by the UE. For example, when the UE needs to hand over and the current ongoing PDU session executed by the UE needs to request resource of network slice 1, although the first node serves as one the candidate cells for handover, if the resource of the network slice 1 on the first node is shortage (e.g., number of RRC users in network slice 1 is shortage or number of DRBs in network slice 1 is shortage), the sixth node may not select the first node as the target base station for the UE. In this way, it is possible to ensure that the most suitable target cell is selected for the UE for providing continuous services, and it is also possible to reduce unnecessary network signaling overhead and reduce risk of handover failure.

2. If the sixth node serving as a master base station intends to select a secondary node for the UE, the sixth node decides whether to select a cell under the first node as a secondary cell for the UE or to select the first node as a secondary node by considering related information about a network slice resource status from the first node and the network slice information requested by the UE. In this way, it is possible to ensure that the most suitable target cell is selected for the UE for providing dual connectivity services, and it is also possible to reduce unnecessary network signaling overhead and reduce risk of secondary node addition failure.

3. If the sixth node serving as A CU-CP intends to select a CU-UP for the UE when the UE is establishing a PDU session, the sixth node decides whether to select the first node as a user plane node serving the requested network slice for the UE by considering related information about a network slice resource status from the first node serving as a CU-UP and the network slice information requested by the UE. In this way, it is possible to ensure that the most suitable CU-UP is selected for the UE, and it is also possible to reduce unnecessary network signaling overhead and reduce risk of session establishment failure.

4. When aiming at load balancing, the sixth node makes decision of load balancing better according to related information about a network slice resource status sent by an neighbor base station(s) (e.g., the first node) and the current network slice resource status of the sixth node, for providing all users with best services as far as possible.

With the forgoing session establishment and control method provided by the present disclosure, before the procedure of UE handover or session establishment, related information about a network slice resource status is exchanged in advance to assist a serving base station to select the most suitable cell for providing services for the UE, therefore reducing the risk of handover failure, ensuring the continuity of the service, improving user experience, increasing the utilization of network resources and increasing the income of the operator.

It should be noted that in the above various embodiments, the Allowed NSSAI is network slice information which is allowed to be used by the UE by the network. That is, if the UE intends to initiate a PDU session establishment request, it may select one S-NSSAI from the Allowed NSSAI for initiating the PDU session establishment request. Wherein the name of the Allowed NSSAI is not limited thereto.

Based on the principles identical to those of methods provided by the above embodiments of the present disclosure, a session establishment and control apparatus is provided by the present disclosure, the apparatus may include a receiving module and an resource allocation module, wherein:
the receiving module is used for receiving related information about usage of a network slice resource from a second node; and
the resource allocation module is used for allocating a requested PDU session with other available resource by considering the information when a network slice resource corresponding to the requested PDU session is not supported or shortage.

Optionally, the above information may include at least one of the following items of information:
related information for restricting simultaneous use of network slices;
related information for restricting use time of a network slice;
related information for restricting use location of a network slice;
related information for restricting use frequency of a network slice;
related information on whether network slice resources can be pre-empted or not; and
related information on whether a dedicated network slice resource can be used or not.

In some optional embodiments, there is provided a session establishment and control apparatus, the apparatus may include a sending module for sending related information about the allocated other available resource to the second node or to a third node via the second node.

Optionally, the foregoing related information about the allocated other available resource includes at least one of the following items of information:
information for indicating a way of the PDU session or QoS flows in the PDU session being allocated with the other available resource;
information for indicating a S-NSSAI corresponding to the other available resource allocated to the PDU session or QoS flows in the PDU session;
information for indicating a resource type corresponding to the other available resource allocated to the PDU session or QoS flows in the PDU session;
information for indicating time information when the other available resource allocated to the PDU session or QoS flows in the PDU session is used;
information for indicating data amount when the other available resource allocated to the PDU session or QoS flows in the PDU session is used; and
information for indicating that the PDU session or QoS flows in the PDU session have been allocated with the other available resource.

Optionally, the sending module is further used for sending the related information about the allocated other available resource to a sixth node; wherein the related information about the allocated other available resource includes at least one of the following items of information:
statistical report information on usage of other available resource by a network slice; and
related information for indicating the status of other available resource being used.

In other optional embodiments, there is provided a session establishment and control apparatus, the apparatus may include:
a sending module, for sending, to the user equipment, UE, related information for restricting network slice(s), and sending, to the UE the related information for indicating performing of restricting network slice(s) when the UE is being scheduled.

Optionally, the related information for restricting network slice(s) is a restriction rule for restricting network slice scheduling, and the related information for indicating performing of restricting network slice(s) is a restriction index; or

The related information for restricting network slice(s) includes a configuration list for scheduling weights, and the related information for indicating performing of restricting network slice(s) is a configuration profile index for scheduling weights.

Optionally, the sending module is specifically used for sending the related information for indicating performing of restricting network slice(s) to the UE based on a comparison result between the sum of rates of logical channels corresponding to current network slice and a given slice-maximum bite rate (S-MBR).

The comparison result between the sum of rates of logical channels corresponding to current network slice and a given slice-maximum bite rate (S-MBR) includes any one of the following:
the sum of rates of logical channels corresponding to current network slice exceeds the given S-MBR; and
the sum of rates of logical channels corresponding to current network slice does not exceed the given S-MBR.

In other optional embodiments, there is provided a session establishment and control apparatus, the apparatus may include:
a processing module, for determining network slice information requested by a user equipment, UE, and supported by a fourth node; and
a sending module, for sending the network slice information requested by the UE and supported by the fourth node to a second node.

Optionally, the processing module is specifically used for determining the network slice information requested by the UE and supported by the fourth node according to at least one of the following items of information:
related information about target network slice selection assistance information (NSSAI), related information about allowed NSSAI, measurement reports from the UE, and the network slice information supported by the fourth node.

Optionally, the sending module is specifically used for:
obtaining the related information about target network slice selection assistance information (NSSAI) from a fifth node;
when a network slice in the target NSSAI is supported by the fourth node, sending the network slice information requested by the UE and supported by the fourth node to the second node.

In other optional embodiments, there is provided a session establishment and control apparatus, the apparatus may include:
a receiving module and a sending module, wherein:
the receiving module is used for receiving information for indicating that a PDU session resource needs to be established on a secondary node from the second node; and
the sending module is used for sending a related request message about secondary node addition or modification to the fourth node.

The apparatuses described above may be implemented as the first node in the present disclosure.

Based on the principles identical to those of methods provided by the above embodiments of the present disclosure, a session establishment and control apparatus is also provided by the present disclosure, the apparatus may include a receiving module and a processing module, wherein:
the receiving module is used for receiving the network slice information requested by a UE and supported by a fourth node which is sent by a first node; and
the processing module is used for determining allowed network slice selection assistance information (NSSAI) for the UE or reassigning the allowed NSSAI by considering the network slice information requested by the UE and supported by the fourth node.

In some optional embodiments, there is provided a session establishment and control apparatus, the apparatus may include:
a sending module, for sending information for indicating that a PDU session resource needs to be established on a secondary node to a first node.

The apparatuses described above may be implemented as the second node in the present disclosure.

Based on the principles identical to those of methods provided by the above embodiments of the present disclosure, a session establishment and control apparatus is also provided by the present disclosure, the apparatus may include a receiving module and a processing module, wherein:
the receiving module is used for receiving related information for restricting network slice(s) which is sent by a first node and for receiving related information for indicating performing of restricting network slice(s) which is sent by the first node when the first node is scheduling a UE; and
the processing module is used for performing uplink scheduling process according to the related information for restricting network slice(s) and the related information for indicating performing of restricting network slice(s).

Wherein the apparatus may be implemented as a user equipment.

Based on the principles identical to those of methods provided by the above embodiments of the present disclosure, an electronic device is also provided by the present disclosure, the electrical device includes a memory and a processor; at least one of the programs is stored in the memory, and when executed by the processor, may implement a method provided in any of optional embodiments of the present application.

Optionally, the electronic device may be implemented as a user equipment, and at least one processor is included in the user equipment. The at least one processor is configured to perform a method executed by the user equipment provided in any of optional embodiments of the present application.

Optionally, the electronic device may be implemented as a base station, and at least one processor is included in the base station. The at least one processor is configured to perform a method executed by the base station provided in any of optional embodiments of the present application.

Optionally, the electronic device may be implemented as a core network node device, and at least one processor is included in the core network node device. The at least one processor is configured to perform a method executed by the core network node device provided in any of optional embodiments of the present application.

FIG. 9 illustrates a structural schematic diagram of an electronic device provided in an optional embodiment of the present application, as shown in FIG. 9. An electronic device 4000 as shown in FIG. 9 includes a processor 4001 and a memory 4003. Wherein, the processor 4001 is connected with the memory 4003, for example, through the bus 4002.

Optionally, the electronic device 4000 may further include a transceiver 4004, and the transceiver 4004 may be used for data interaction between the electronic device and other electronic devices, such as data transmission and/or data reception and so on. It should be noted that, in practical applications, the transceiver 4004 is not limited to one, and the structure of the electronic device 4000 does not constitute a limitation to the embodiments of the present application.

The processor 4001 may be a central processing unit (CPU), a general-purpose processor, a digital signal processor (DSP), an application-specific integrated circuit (ASIC), a field programmable gate array (FPGA) or other programmable logic devices, transistor logic devices, hardware components, or any combination thereof. The processor can implement or execute various exemplary logic blocks, modules and circuits described in the disclosure of the present application. The processor 4001 may also be a combination for realizing computing functions, such as a combination including one or more microprocessors, a combination of a DSP and a microprocessor, and so on.

The bus 4002 may include a path to transfer information between the components described above. The bus 4002 may be a peripheral component interconnect (PCI) bus or an extended industry standard architecture (EISA) bus and so on. The bus 4002 may be divided into an address bus, a data bus, a control bus, and so on. For case of presentation, only one thick line is shown in FIG. 9, but it does not mean that there is only one bus or one type of bus.

The memory 4003 may be a Read Only Memory (ROM) or other types of static storage devices that may store static information and instructions, a Random Access Memory (RAM) or other types of dynamic storage devices that may store information and instructions, it may also be electrically erasable and programmable read only memory (EEPROM), compact disc read only memory (CD-ROM) or other optical disk storage, optical disk storage (including compressed compact disc, laser disc, compact disc, digital versatile disc, blue-ray disc, etc.), magnetic disk storage media inclusion or, other magnetic storage devices, or any other medium capable of carrying or storing desired program codes having forms of instructions or data and capable of being access by a computer. However, it is not limited thereto.

The memory 4003 is used for storing application program codes (computer programs) for executing the scheme of the present application, and the execution is controlled by the processor 4001. The processor 4001 is used to execute application program codes stored in the memory 4003 to implement the content shown in the foregoing method embodiments.

According to below R17 Slicing enhancement WI objectives [1], it is expected to discuss the slice resource remapping in case of resource shortage to support the service continuity.

1. Support service continuity, in cases of resource shortage for the current slice in the target cell, but resources of other slices or other cells can be used based on slice resource management while maintaining the S-NSSAI unchanged. Solutions include Configuration based solution, Slice resource re-partitioning solution and Multi-carrier radio resource sharing solution, as described in TR 38.832 [RAN3]
a. Determine further potential capabilities required to OAM. Coordination with SA5 is needed.
b. Determine and specify the necessary signalling on NG and Xn interfaces (e.g. to report RAN internal slice resource change) if any. Coordination with SA2 and SA5 may be needed.

The following solutions are recommended by RAN3 to be specified in normative phase for scenario 1,3,5,6 according to TS 38.832 [2]. Study in SA5 is needed if further capabilities are deemed required by RAN in normative phase beyond those already supported:
Configuration based Solution (section 6.2.3.1)
Slice resource re-partitioning (section 6.2.3.2)
Multi-carrier radio resource sharing (section 6.2.3.3)

In our understanding, the DC solution has no RAN impact. For the configuration based solution and slice resource re-partitioning, they can be discussed as slice resource remapping, the difference between the two is the former will remap all the types of resources, while the latter will only remap a subset of the resource types, and the types of resources could be spectrum resource, transport resource or hardware resources.

In this contribution, we would like to discuss the configuration based solution and slice resource re-partitioning in the following aspects.

Restrictions and policies, i.e. whether NG-RAN needs to consider the restrictions and policies from the 5GC to make slice resource mapping decision.

Resource change report, i.e. after the resource change, whether the NG-RAN needs to notify the internal resource change information to 5GC or source gNB during mobility.

For configuration based solution, in [2], below can be further discussed:
But the following needs to be further studied, e.g., for the S-NSSAI 1,
it can explicitly use resources belonging to which S-NSSAIs;
it can use the dedicated but not used resources of other S-NSSAIs;
it can preempt the used prioritized and/or shared resources from other S-NSSAIs.

In our understanding, the above aspects can also be applied to Slice resource re-partitioning, so the following discuss can be applied to both of the solutions.

For the first bullet, “it can explicitly use resources belonging to which S-NSSAIs;” i.e. whether the PDU session associated with slice 1 can explicitly use resources belonging to other slices, we think some restrictions from the 5GC should be considered, such as NSSRG information (i.e. Network Slice Simultaneous Registration Group, which means the slices cannot be used for a UE simultaneously if they are not in the same NSSRG, according to [3] TS23.501), if not considered, the result of the resource remapping is not satisfied the requirements of the 5GC, below two example cases may exist:
Example 1 if slice 1 and slice 2 are not in the same NSSRG, when the resource for slice 1 is shortage, the serving gNB cannot use the resource of the slice 2 for slice 1.
Example 2 if there are on-going sessions associated with slice 1 and slice 3, but the resource for slice 1 is shortage, and slice 2 and slice 3 are not in the same NSSRG, in this case, the serving gNB cannot use the resources of the slice 2 for slice 1, as slice 2 and slice 3 cannot be used simultaneously.

To avoid selecting the wrong slice resources which may break the rules of E2E slice usage, the serving node should be aware of the restrictions, so that it can make a proper decision of slice resource re-mapping.

Proposal 1, the restrictions from 5GC should be considered to decide whether the resources of other slices can be used.

For the second bullet “it can use the dedicated but not used resources of other S-NSSAIs”, i.e. whether the PDU session associated with slice 1 can use the dedicated but not used resources of other S-NSSAI. We think whether this PDU session is capable of using dedicated resources should refer to the policy information from the 5GC, for example, if the UE is a VIP customer or the traffic transmitted on this PDU session is very critical and important, the PDU session or a subset of the QoS flows in the PDU session can use the dedicated/prioritized resources of other slices. Considering SA2 expects limiting specification impact in R17, QoS information for each QoS flow can be used as policy information to help the serving gNB to make slice resource remapping decision. So it is feasible that the serving gNB consider the known information (e.g. QoS information) to decide whether the PDU session or a subset of the QoS flows in the PDU session can use the dedicated/prioritized resources of other slices.

Proposal 2, the PDU session or a subset of the QoS flows in the PDU session associated with a slice which is resource shortage can use the dedicated/prioritized resources of other slices according to the known information (e.g. QoS information)

Proposal 3, RAN3 discuss whether new information is needed from 5GC to decide whether dedicated resources of other slices can be used.

For the third bullet “it can preempt the used prioritized and/or shared resources from other S-NSSAIs.”, i.e. whether the PDU session associated with slice 1 can pre-empt the prioritized and/or shared resources from other slices. This feature should also consider the policy from 5GC, whether it's slice specific policy or it's ARP, we don't think NG-RAN can decide this by itself.

Proposal 4, RAN3 discuss whether ARP is considered or new information is needed from 5GC to decide whether the resources of other slices can be pre-empted.

After deciding the resource change, the resource change related information should be reported. And the information will be different for different purpose.

If it's for the charging purpose, the CN should know the change of the slice resource, the resource type of the changed resource, the data volume or the start/end time of the change.

Proposal 5, the PDU session, the change of the slice resource, the resource type of the changed resource, the data volume or the start/end timestamp of the change should be notified to CN if it's for charging purpose.

If the resource change is performed during mobility, the change of slice resource indication should be notified to the source gNB, so that the source gNB can consider this change to make handover decision in case of CHO (e.g. the source gNB may not select the gNB with slice resource change indication as a candidate for the UE), or the source gNB can consider this change to make better handover decision for the following handover decision (e.g. the source gNB may not select the gNB with slice resource change indication as a target for the following handover UEs).

Proposal 6, the slice resource change indication should be included in handover request acknowledge message to notify the source gNB for making better handover decision.

According to the conclusions in [2], below scenarios are recommended by RAN3 to be specified in normative phase:
Resource shortage in case of Intra-RA mobility
Slice resource shortage for MR-DC
Slice overload in RAN node in absence of mobility

The same updates should be applied to E1/F1 for split architecture and Xn for MR-DC if the proposals above are agreed.

Proposal 7, the same updates should be applied to E1/F1/Xn if the proposals above are agreed.

In this paper, we discuss the evaluation of slice re-mapping policy and the following proposals are made:

Proposal 1, the restrictions from 5GC should be considered to decide whether the resources of other slices can be used.

Proposal 2, the PDU session or a subset of the QoS flows in the PDU session associated with a slice which is resource shortage can use the dedicated/prioritized resources of other slices according to the known information (e.g. QoS information)

Proposal 3, RAN3 discuss whether new information is needed from 5GC to decide whether dedicated resources of other slices can be used.

Proposal 4, RAN3 discuss whether ARP is considered or new information is needed from 5GC to decide whether the resources of other slices can be pre-empted.

Proposal 5, the PDU session, the change of the slice resource, the resource type of the changed resource, the data volume or the start/end timestamp of the change should be notified to CN if it's for charging purpose.

Proposal 6, the slice resource change indication should be included in handover request acknowledge message to notify the source gNB for making better handover decision.

Proposal 7, the same updates should be applied to E1/F1/Xn if the proposals above are agreed.

Issue 1: How to setup or maintain service continuity for PDU sessions associated with a specific slice, when this slice is not supported by the serving/target cell.

Issue description: based on current spec, it is not possible to setup/keep a PDU session which associates with a non-supported slice by the serving/target cell.

Solution description: the gNB hosting the serving/target cell sets up DC/CA, or making slice re-mapping decisions for non-supported slice by the serving/target cell.

Issue 2: How to support enhanced slice-based load balancing by introducing more slice-based load metrics for reporting.

Issue description: based on current spec, only per-slice PRB usage and per-slice CAC metrics are exchanged between gNBs, which may not be enough for slice-based load balancing.

Solution description: introduce per slice DRB usage and RRC connections as new load metrics for slice-based load balancing.

In R17, RAN slicing to support slice-based service continuity was investigated, and corresponding chapters related to slice-based service continuity in TR 38.832 has been provided according to the discussion during R17 RAN Slicing SI, wherein two basic scenarios have been investigated and discussed,

How to support slice-based service continuity when the target cell is in resource shortage;

How to support slice-based service continuity when the target cell does not support a slice.

After R17 SI, a following WI for RAN slicing in R17 has been done which only solves the scenario when the target cell is in slice resource shortage. And because of the limited time for discussion in R17 RAN Slicing WI,

The solutions to support slice-based service continuity (including slice re-mapping) when the target cell does not support the slice (as given by TR 38.832) have not been discussed and specified.

The solutions to support slice-based initial access when the serving cell does not support the slice have not been discussed so far.

In addition, in R17 the load metrics as per slice, which is mainly used for the enhancement of Mobility Load Balancing, has been primarily discussed. At the end of R17, only per-slice PRB usage is introduced in specs, which does not preclude to introduce additional per-slice load metrics in future releases.

6.2.1.2.2 Slice Remapping for non-mobility case

6.2.1.2.2.1 Slice Remapping decision in SN for MR-DC case

1. The MN sends the SN Addition Request message to the SN.

2. If the UE's ongoing slice(s) is rejected by the SN, based on the slice re-mapping policy described in clause 6.2.1, the SN makes the slice re-mapping/fallback decision. The SN shall include the slice re-mapping/fallback decision in the SN Addition Request Acknowledge message to the MN.

3. The MN may send the slice re-mapping/fallback decision to the AMF through the PDU Session Modification Indication message.

4. The AMF responds the PDU Session Modification Confirmation message.

6.2.1.2.2.2 Slice Remapping decision in MN for MR-DC case

1. The MN makes the slice re-mapping/fallback decision and include the decision in the SN Addition Request message to the SN.

2. The SN confirms the slice re-mapping/fallback decision made by the MN in the SN Addition Request Acknowledge message.

3. The MN may send the slice re-mapping/fallback decision to the AMF through the PDU Session Modification Indication message.

4. The AMF responds the PDU Session Modification Confirmation message. 4 Objective

4.1 Objective of SI or Core part WI or Testing part WI

The work item aims to standardize the further enhancement on RAN support of network slicing. Detailed objectives of the work item are:

Further enhancement on RAN support of slicing, including specify mechanisms and signalling to support MT triggered slice aware cell reselection. [RAN2]

For non-supported slice by the serving cell, specify mechanism to support UE to access to the intended slice by setting up DC or CA. [RAN2, RAN3]

Potential RAN impacts of SA2 slicing enhancement in Rel-18

For non-supported slice by target NG-RAN node in case of inter-RA mobility scenario, if end-to-end feasibility is addressed in SA2, specify the solutions to support slice remapping for which the remapping decision is made in NG-RAN node as described in TR 38.832, section 6.2.1. [RAN3]

17.2. Support Service Continuity

#RANSlicing2_Service_Continuity

‘Slice pre-emption’:
3 options to solve potential pre-emption conflict and decide which way to go.
It is not necessary to introduce slice level priority.
Existing tool is enough from the perspective of pre-emption mechanism Or introduce a per-slice (or per-PDU session) pre-emption mechanism.

Others:
Two solutions to report slice resource shortage in HO Request Acknowledge and find out which one to specify.
Whether to allow SCG resources outside of RA is based operator policy, the AMF sends to gNB the RA of the UE in the initial context setup message.
The slice resource change indication including resource type (at least RRC connected users, DRB) should be included in handover request acknowledge message to notify the source gNB for making better handover decision.
Add the main objective (supporting slice service continuity), and applicable scenarios (e.g., mobility, and Slice overload in RAN node in absence of mobility) for the proposed two solutions at the stage 2 BLCR.
Capture agreements and open issues
Provide TPs if agreeable

(Nok-moderator)

Summary of offline disc R3-221042 noted

Resource shortage in Mobility scenarios (to be continued online if time allows or at next meeting)

Whether to signal time critical handover to help target gNB determine if MCRS using DC can be used at target
(to be debated: handover time critical is how quick the connection with source gNB will disappear is not related to delay criticality of an application)

Whether a slice resource change indication should be included in the handover request acknowledge message to help source gNB in future handover decisions
(to be debated: per slice RRC connected UEs and per slice DRBs are currently not exchanged over Xn Resource Status procedure)

It should be understood that, although various steps in the flowcharts of the drawings are shown in sequence as indicated by arrows, these steps are not necessary to be executed in sequence according to the sequence indicated by arrows. Unless explicitly stated herein, there are no strict limitations on the sequence of execution for those steps, and those steps may be executed in other orders. Also, at least part of the steps in the flowcharts of the drawings may include a plurality of sub-steps or a plurality of stages, and these sub-steps or stages are not necessary to be executed and finished at the same moments but may be executed at different moments. The execution order of these sub-steps or stages is not necessarily to be performed in sequence but may be executed by turns or alternately with other steps or the sub-steps of other steps or at least part of the stages.

The foregoing are only some implementations of the present invention, it should be noted that, for a person of ordinary skill in the art, several improvements and modifications may be made without departing from the principles of the present invention, and these improvements and modifications should also be regarded as the scope of the present invention.

1-15. (canceled)

16. A method of a first node in a wireless communication, the method comprising:
determining to remap a network slice resource for a requested packet data unit (PDU) session; and
transmitting, to a second node, a first message including first information related to remapping the network slice resource for the request PDU session.

17. The method of claim 16, further comprising
receiving, from a third node, a second message including second information related to usage of a network slice resource for the requested PDU session;
wherein the second information related to usage of a network slice resource includes at least one of:
information for restricting simultaneous use of network slices;
information for restricting use time of a network slice;
information for restricting use location of a network slice;
information for restricting use frequency of a network slice;
information on whether a network slice is able to pre-empt other network slice resource or not; and
information on whether a dedicated network slice resource can be used or not.

18. The method of claim 17, wherein a network slice of the network slice resource for the requested PDU session is not supported and rejected by the third node.

19. The method of claim 16, wherein the first information related to remapping the network slice resource includes at least one of:
information for indicating a way of a PDU session or quality of service (QOS) flows in the PDU session being allocated with an available resource;
information for indicating a single-network slice selection assistance information (S-NSSAI) corresponding to the available resource allocated to the PDU session or QoS flows in the PDU session;
information for indicating a resource type corresponding to the available resource allocated to the PDU session or QoS flows in the PDU session;
information for indicating time information in case that the available resource allocated to the PDU session or QoS flows in the PDU session is used;
information for indicating data amount in case that the available resource allocated to the PDU session or QoS flows in the PDU session is used; and
information for indicating that the PDU session or QoS flows in the PDU session have been allocated with the available resource.

20. The method of claim 16,
wherein the first node comprises a master node of a base station, and
wherein the second node comprises a core network.

21. A method of a second node in a wireless communication, the method comprising:
receiving, from a first node, a first message including first information related to remapping a network slice resource.

22. The method of claim 21, wherein the first information related to remapping the network slice resource includes at least one of:
information for indicating a way of a PDU session or quality of service (QOS) flows in the PDU session being allocated with an available resource;
information for indicating a single-network slice selection assistance information (S-NSSAI) corresponding to the available resource allocated to the PDU session or QoS flows in the PDU session;
information for indicating a resource type corresponding to the available resource allocated to the PDU session or QoS flows in the PDU session;
information for indicating time information in case that the available resource allocated to the PDU session or QoS flows in the PDU session is used;
information for indicating data amount in case that the available resource allocated to the PDU session or QoS flows in the PDU session is used; and
information for indicating that the PDU session or QoS flows in the PDU session have been allocated with the available resource.

23. The method of claim 21,
wherein the first node comprises a master node of a base station, and
wherein the second node comprises a core network.

24. A first node in a wireless communication, the first node comprising:
a transceiver; and
at least one processor coupled to the transceiver and configured to:
determine to remap a network slice resource for a requested packet data unit (PDU) session, and
transmit, to a second node, a first message including first information related to remapping the network slice resource for the request PDU session.

25. The first node of claim 24, wherein at least one processor is further configured to:
receive, from a third node, a second message including second information related to usage of a network slice resource for the requested PDU session, and
wherein the second information related to usage of a network slice resource includes at least one of:
information for restricting simultaneous use of network slices,
information for restricting use time of a network slice,
information for restricting use location of a network slice,
information for restricting use frequency of a network slice,
information on whether a network slice is able to pre-empt other network slice resource or not, and
information on whether a dedicated network slice resource can be used or not.

26. The first node of claim 25, wherein a network slice of the network slice resource for the requested PDU session is not supported and rejected by the third node.

27. The first node of claim 24, wherein the first information related to remapping the network slice resource includes at least one of:
information for indicating a way of a PDU session or quality of service (QOS) flows in the PDU session being allocated with an available resource,
information for indicating a single-network slice selection assistance information (S-NSSAI) corresponding to the available resource allocated to the PDU session or QoS flows in the PDU session,
information for indicating a resource type corresponding to the available resource allocated to the PDU session or QoS flows in the PDU session,
information for indicating time information in case that the available resource allocated to the PDU session or QoS flows in the PDU session is used,
information for indicating data amount in case that the available resource allocated to the PDU session or QoS flows in the PDU session is used, and
information for indicating that the PDU session or QoS flows in the PDU session have been allocated with the available resource.

28. The first node of claim 24,
wherein the first node comprises a master node of a base station, and
wherein the second node comprises a core network.

29. A second node in a wireless communication, the second node comprising:
a transceiver; and
at least one processor coupled to the transceiver and configured to receive, from a first node, a first message including first information related to remapping a network slice resource.

30. The second node of claim 29, wherein the first information related to remapping the network slice resource includes at least one of:
information for indicating a way of a PDU session or quality of service (QOS) flows in the PDU session being allocated with an available resource;
information for indicating a single-network slice selection assistance information (S-NSSAI) corresponding to the available resource allocated to the PDU session or QoS flows in the PDU session;
information for indicating a resource type corresponding to the available resource allocated to the PDU session or QoS flows in the PDU session;
information for indicating time information in case that the available resource allocated to the PDU session or QoS flows in the PDU session is used;
information for indicating data amount in case that the available resource allocated to the PDU session or QoS flows in the PDU session is used; and
information for indicating that the PDU session or QoS flows in the PDU session have been allocated with the available resource.

31. The second node of claim 29,
wherein the first node comprises a master node of a base station, and
wherein the second node comprises a core network.
